(19) United States
(12) Patent Application Publication
(10) Pub. No.: US 2019/0358883 A1
(43) Pub. Date: Nov. 28, 2019

(54) MULTI-ORIFICE NOZZLE AND USES THEREOF

(71) Applicant: HIGHCON SYSTEMS LTD., Yavne (IL)

(72) Inventors: Ron OR, Tel Aviv (IL); Michael KARP, Petach-Tikva (IL); Claudio ROTTMANN, Modiin (IL); Dana Mizrachi Cohen, Herzelia (IL)

(21) Appl. No.: 16/535,085

(22) Filed: Aug. 8, 2019

Related U.S. Application Data
(63) Continuation-in-part of application No. PCT/IB2018/050792, filed on Feb. 8, 2018.

(30) Foreign Application Priority Data
Feb. 8, 2017 (GB) 1702027.2

(51) Int. Cl. B29C 48/345; B05B 1/14; B05C 5/02; B29C 48/154

(52) U.S. Cl. CPC B29C 48/345; B29C 48/154; B05C 5/0208; B05B 1/14

(57) ABSTRACT

A multi-orifice nozzle suitable for drawing a plurality of line rules in parallel, line rules disposed in parallel drawn using the multi-orifice nozzle, and systems and methods for using such line rules for impressing a substrate with a plurality of line indentations disposed in parallel.

### RELATED APPLICATIONS

The present application is a continuation-in-part of PCT/IB2018/050792, filed 8 Feb. 2018 and entitled “Multi-Orifice Nozzle and Uses Thereof”, which claims priority from GB Patent Application Number GB1702027.2 filed Feb. 8, 2017 and having the same title. The contents of both of the aforesaid applications are incorporated herein by reference.

### FIELD AND BACKGROUND OF THE INVENTION

The present invention relates to systems and methods for drawing rule dies and, more particularly, to a system including a multi-orifice nozzle for drawing multiple parallel rule dies, and to die and counter die systems and methods using such multiple parallel rule dies.

The rapid evolution of trade around the world (globalization) creates a significant demand for packaging in order to transfer/distribute goods to different remote areas. Packaging of products for shipping, display and protection takes on a major role in the market today. The package in which the goods are packed and presented, in a store for example, may determine if the goods will be appealing to a potential buyer in the store or not. Thus the packaging appearance can have a direct effect on the sales of merchandise.

A known preliminary requirement, in order to construct a package, is preparing or purchasing a pre-treated cardboard and/or paper based material. Pre-treatment of a cardboard may include the following actions: creating folding lines along the cardboard to ease or assist in the folding of the cardboard and provide accurate folding of the cardboard; piercing the cardboard in different areas; creating embossments in different areas of the cardboard; cutting the raw cardboard into predefined profiles; and so on.

Some common techniques for preparing a pre-treated cardboard include the placing the cardboard between dies, one of the dies including rules. The rules may be steel-rules, or may be formed of a polymeric material. Examples of methods for formation of polymeric rules and of the resulting polymeric rule dies are disclosed in the Applicant's U.S. Pat. Nos. 8,777, 828 and 9,102,818, as well as in the Applicant's US Patent Publication No. 2017/0113432, all of which are incorporated by reference for all purposes as if fully set forth herein.

As disclosed in the Applicant's previous publications, polymeric rules are printed using a suitable nozzle. In the prior art, nozzles include a single orifice such that the rules are printed one at a time. However, this provides limitations as to the possible distance between rules, and requires extreme caution in alignment in order to print parallel rules, particularly when they are close together.

The Applicant's U.S. Pat. No. 9,545,638, which is incorporated herein by reference for all purposes as if fully set forth herein, discloses a nozzle for printing polymeric rules, the nozzle having multiple orifices. The multiple orifices of the nozzle are aligned, such that one orifice is used when printing in a first direction and another is used when printing in the opposite direction. However, the multi-orifice nozzle does not facilitate printing of multiple parallel rules at the same time.

### SUMMARY OF THE INVENTION

The present invention relates to systems and methods for drawing rule dies. Specifically, it is an object of the invention to provide a nozzle that facilitates printing of multiple parallel polymeric rules at the same time, while ensuring that the rules do not merge with one another and maintain the desired rule profile.

According to one aspect of the present invention there is provided a nozzle connectable to a rule drawing system for drawing a viscous material onto a substrate to form a plurality of parallel line rules of a rule die, including:

a nozzle body including a hollow bore adapted to receive the viscous material, the nozzle body having an exterior surface shaped and configured for connection to the rule drawing system; and

a nozzle tip terminating in a plurality of orifices optionally arranged along a straight line, each of the plurality of orifices being in fluid communication with the bore, the plurality of orifices adapted to allow passage of the viscous material therethrough, thereby to form the plurality of parallel line rules.

In some embodiments, the distance between each two adjacent ones of the plurality of orifices is in the range of 0.3 mm to 6.0 mm, 0.5 mm to 5.5 mm, 0.5 mm to 5.0 mm, 0.5 mm to 4.5 mm, 0.5 mm to 4.0 mm, 0.5 mm to 3.5 mm, 0.5 mm to 3.0 mm, 0.5 mm to 2.5 mm, or 0.5 mm to 2.0 mm.

In some embodiments, distal orifices of the plurality of orifices, located at ends of the line, have a greater cross section than others of the plurality of orifices.

In some embodiments, each two adjacent ones of the plurality of orifices are separated by a common wall. In some embodiments, each common wall has a width in the range of 0.3 mm to 6.0 mm, 0.5 mm to 5.5 mm, 0.5 mm to 5.0 mm, 0.5 mm to 4.5 mm, 0.5 mm to 4.0 mm, 0.5 mm to 3.5 mm, 0.5 mm to 3.0 mm, 0.5 mm to 2.5 mm, or 0.5 mm to 2.0 mm.

In some embodiments, each of the plurality of orifices includes a bottom opening substantially parallel to a bottom surface of the nozzle body.

In some embodiments, each of the plurality of orifices includes a single side opening disposed perpendicularly to a bottom surface of the nozzle body, and in parallel to the straight line.

In some embodiments, in each of the plurality of orifices, the single side opening and the bottom opening form an L shape. In some embodiments, each of the plurality of orifices has a width in the range of 0.5 mm to 1.0 mm, 0.6 mm to 0.9 mm, 0.65 mm to 0.85 mm, 0.7 mm to 0.85 mm, or 0.75 mm to 0.85 mm.

In some embodiments, each of the plurality of orifices has a height in the range of 1.1 mm to 1.5 mm, 1.15 mm to 1.45 mm, 1.2 mm to 1.4 mm, or 1.25 mm to 1.35 mm.

In some embodiments, for each of the plurality of orifices, a ratio of a height of the orifice to a width of the orifice is in the range of 1 to 3, 1.1 to 2.7, 1.2 to 2.5, 1.4 to 2.4, 1.5 to 2.3, 1.7 to 2.1, 1.8 to 2, or 1.8 to 1.9.

In some embodiments, openings of the plurality of orifices all have the same cross sectional shape.

In some embodiments, openings of some of the plurality of orifices have a first cross sectional shape, and openings of others of the plurality of orifices have a second cross sectional shape, the first and second cross sectional shapes being different from one another.

In some embodiments, openings of at least some of the plurality of orifices have a rectangular cross section. In some embodiments, openings of at least some of the plurality of orifices have a trapezoidal cross section. In some embodiments, openings of at least some of the plurality of orifices have an arcuate cross section. In some embodiments, openings of at least some of the plurality of orifices have a triangular cross section.

In some embodiments, a number of orifices in the plurality of orifices is in the range of 2 to 30, 2 to 28, 2 to 25, 2 to 22, 2 to 20, 2 to 18, or 2 to 15.

According to another aspect of the present invention there is provided a method for producing a male die suitable for impressing a relief pattern, the method including:

mounting a die base onto a rule drawing system including the nozzle as described hereinabove; and

using the rule drawing system, pressuring the viscous material via the bore and out of the plurality of orifices onto the die base, thereby to form a plurality of line rules disposed in parallel on the die base.

In some embodiments, the plurality of line rules each have a height in the range of 0.3 mm to 5.0 mm, 0.3 mm to 4.5 mm, 0.3 mm to 4.0 mm, 0.3 mm to 3.5 mm, 0.3 mm to 3.0 mm, 0.4 mm to 2.5 mm, or 0.5 mm to 2.0 mm.

In some embodiments, the plurality of line rules have substantially the same height, such that a height difference between any two of the plurality of line rules is not more than 50 micrometers, not more than 40 micrometers, not more than 30 micrometers, or not more than 20 micrometers.

In some embodiments, the plurality of line rules have substantially the same width, such that a width difference between any two of the plurality of line rules is not more than 50 micrometers, not more than 40 micrometers, not more than 30 micrometers, or not more than 20 micrometers.

In some embodiments, the plurality of line rules each have a width, at a base thereof, in the range of 0.3 mm to 5.0 mm. 0.3 mm to 4.5 mm, 0.3 mm to 4.0 mm, 0.3 mm to 3.5 mm, 0.3 mm to 3.0 mm, 0.4 mm to 2.5 mm, or 0.5 mm to 2.0 mm.

In some embodiments, the plurality of line rules each have a width, at a tip thereof, in the range of 0.1 mm to 5.0 mm, 0.1 mm to 4.5 mm, 0.1 mm to 4.0 mm, 0.1 mm to 3.5 mm, 0.1 mm to 3.0 mm, 0.1 mm to 2.5 mm, 0.2 mm to 2.0 mm, 0.3 mm to 1.5 mm, or 0.3 mm to 1.0 mm.

In some embodiments, a distance between two adjacent ones of the plurality of line rules, at a base thereof, is in the range of 0 mm to 5.0 mm, 0.1 mm to 4.5 mm, 0.2 mm to 4.0 mm, 0.3 mm to 3.5 mm, 0.3 mm to 3.0 mm, 0.4 mm to 2.5 mm, or 0.5 mm to 2.0 mm.

In some embodiments, a distance between two adjacent ones of the plurality of line rules, at a tip thereof, is in the range of 0.2 mm to 4.0 mm, 0.3 mm to 3.5 mm, 0.4 mm to 3.5 mm, 0.5 mm to 3.0 mm, 0.6 mm to 2.5 mm, or 0.7 mm to 2.0 mm.

In some embodiments, at least one of the plurality of line rules has a trapezoidal cross section. In some embodiments, at least one of the plurality of line rules has an arcuate cross section. In some embodiments, at least one of the plurality of line rules has a rectangular cross section. In some embodiments, at least one of the plurality of line rules has a triangular cross section.

In some embodiments, the plurality of line rules have substantially the same cross section.

In some embodiments, at least one of the plurality of line rules has a first cross section, and at least one other of the plurality of line rules has a second cross section, the first cross section having a different shape from the second cross section.

In some embodiments, the plurality of line rules includes a number of line rules in the range of 2 to 30, 2 to 28, 2 to 25, 2 to 22, 2 to 20, 2 to 18, or 2 to 15.

In some embodiments, the viscous material includes a polymeric resin.

According to yet another aspect of the present invention there is provided a system for impressing a relief pattern onto a substrate, the relief pattern including a plurality of line indentations disposed in parallel, the system including:

at least one male die including a plurality of line rules disposed in parallel defined on a contact surface thereof;

a compressible counter film including:
a base layer;
a contact layer disposed opposite the contact surface of the at least one male die and spaced therefrom; and
a compressible layer disposed between the base layer and the contact layer and attached thereto,

the contact layer being featureless in a region thereof opposing the relief pattern on the at least one male die; and

a compression mechanism adapted to move the at least one male die and the compressible counter film towards one another in an operative mode;

wherein, in the operative mode, when the substrate is disposed between the contract surface and the contact layer, the compression mechanism moves the at least one male die and the compressible counter film towards one another, such that the at least one male die engages a first broad surface of the substrate and the contact layer of the compressible counter film engages an opposing broad surface of the substrate, so as to impress the relief pattern on the substrate.

In some embodiments, the plurality of line rules each have a height in the range of 0.3 mm to 5.0 mm, 0.3 mm to 4.5 mm, 0.3 mm to 4.0 mm, 0.3 mm to 3.5 mm, 0.3 mm to 3.0 mm, 0.4 mm to 2.5 mm, or 0.5 mm to 2.0 mm.

In some embodiments, the plurality of line rules have substantially the same height, such that a height difference between any two of the plurality of line rules is not more than 50 micrometers, not more than 40 micrometers, not more than 30 micrometers, or not more than 20 micrometers.

In some embodiments, the plurality of line rules have substantially the same width, such that a width difference between any two of the plurality of line rules is not more than 50 micrometers, not more than 40 micrometers, not more than 30 micrometers, or not more than 20 micrometers.

In some embodiments, the plurality of line rules each have a width, at a base thereof, in the range of 0.3 mm to 5.0 mm, 0.3 mm to 4.5 mm, 0.3 mm to 4.0 mm, 0.3 mm to 3.5 mm, 0.3 mm to 3.0 mm, 0.4 mm to 2.5 mm, or 0.5 mm to 2.0 mm.

In some embodiments, the plurality of line rules each have a width, at a tip thereof, in the range of 0.1 mm to 5.0 mm, 0.1 mm to 4.5 mm, 0.1 mm to 4.0 mm, 0.1 mm to 3.5 mm, 0.1 mm to 3.0 mm, 0.1 mm to 2.5 mm, 0.2 mm to 2.0 mm, 0.3 mm to 1.5 mm, or 0.3 mm to 1.0 mm.

In some embodiments, a distance between two adjacent ones of the plurality of line rules, at a base thereof, is in the range of 0 mm to 5.0 mm, 0.1 mm to 4.5 mm, 0.2 mm to 4.0 mm, 0.3 mm to 3.5 mm, 0.3 mm to 3.0 mm, 0.4 mm to 2.5 mm, or 0.5 mm to 2.0 mm.

In some embodiments, a distance between two adjacent ones of the plurality of line rules, at a tip thereof, is in the range of 0.2 mm to 4.0 mm, 0.3 mm to 3.5 mm, 0.4 mm to 3.5 mm, 0.5 mm to 3.0 mm, 0.6 mm to 2.5 mm, or 0.7 mm to 2.0 mm.

In some embodiments, at least one of the plurality of line rules has a trapezoidal cross section. In some embodiments, at least one of the plurality of line rules has an arcuate cross section. In some embodiments, at least one of the plurality of line rules has a rectangular cross section. In some embodiments, at least one of the plurality of line rules has a triangular cross section.

In some embodiments, the plurality of line rules have substantially e same cross section.

In some embodiments, at least one of the plurality of line rules has a first cross section, and at least one other of the plurality of line rules has a second cross section, the first cross section having a different shape from the second cross section.

In some embodiments, the plurality of line rules includes a number of line rules in the range of 2 to 30, 2 to 28, 2 to 25, 2 to 22, 2 to 20, 2 to 18, or 2 to 15.

In some embodiments, the system is adapted to be used, in the operative mode, to impress the relief pattern on at least 5000, at least 10000, at least 20000, at least 30000, or at least 40000 individual substrates, without reduction of quality of the impressed relief pattern.

In some embodiments, the system is adapted to be used, in the operative mode, to impress the relief pattern on at least 1000, at least 1500, or at least 2000, individual substrates per hour.

In some embodiments, the compressible counter film having a compressibility, in a direction perpendicular to a broad face of the compressible counter film, in the range of 2-50% at 1.35 MPa. In some embodiments, the compressible counter film having a compressibility, in a direction perpendicular to a broad face of the compressible counter film, in the range of 5-30% at 1.35 MPa. In some embodiments, the compressibility of the compressible counter film is within the range of 6-30%, 9-25%, 9-20%, or 9-15% at 1.35 MPa.

In some embodiments, the compressible counter film further includes:

a reinforcing fabric layer adapted to provide structural reinforcement to the compressible counter film; and

a rubber layer attached along a broad face thereof to the reinforcing fabric layer.

In some embodiments, the reinforcing fabric layer includes a woven fabric. In some embodiments, the reinforcing fabric layer includes a material selected from the group consisting of polyester, rayon, and cotton. In some embodiments, the reinforcing fabric layer is impregnated with a rubber-based material. In some embodiments, the reinforcing layer has a thickness in the range of 0.15 mm to 1 mm.

In some embodiments, the rubber layer has a thickness in the range of 0.15 mm to 5 mm, 0.15 mm to 4 mm, 0.15 mm to 3 mm, 0.15 mm to 2 mm, or 0.15 mm to 1 mm.

In some embodiments, a first broad face of the rubber layer is attached to a first broad face of the reinforcing layer, the second broad face of the rubber layer is disposed adjacent the base layer, and the second broad face of the reinforcing layer is disposed adjacent the compressible layer.

In some embodiments, the compressible counter film has a thickness in the range of 0.75 mm to 10 mm, 1 mm to 9 mm, 2 mm to 8 mm, or 3 mm to 7 mm.

In some embodiments, the contact layer of the compressible counter film having a Shore A hardness in the range of 10 to 80 or 20 to 70.

In some embodiments, the compressible counter film further includes a surface modulating layer disposed between the base layer and the contact layer and adapted such that, in the operative mode, when pressure applied to the contact layer exceeds an amount of pressure required to fully compress the compressible layer, the surface modulating layer responds by modulating at least one of a height and a surface area of a deformation formed on the contact layer.

In some embodiments, the compressible counter film has a compressibility, in a direction perpendicular to a broad face of the compressible counter film, in the range of 5-30%, 6-30%, 9-25%, 9-20%, or 9-15% at 1.35 MPa.

In some embodiments, the surface modulating layer is attached along a first broad face thereof to the compressible layer and along a second broad face thereof to the contact layer.

In some embodiments, the surface modulating layer is adapted to inhibit the contact layer from separating from the compressible layer or from being rotationally shifted relative thereto during impression of the relief pattern on the substrate.

In some embodiments, the surface modulating layer is adapted to increase an amount of pressure that can be applied to the contact layer at a time of impression without damaging the substrate or the relief pattern impressed thereon.

In some embodiments, the surface modulating layer has a thickness in the range of 0.15 mm to 1 mm. In some embodiments, the surface modulating layer includes a fabric layer impregnated with a rubber-based material. In some embodiments, the fabric layer includes at least one material selected from the group consisting of polyester, rayon, and cotton. In some embodiments, the fabric layer includes a woven fabric layer. In some embodiments, the woven fabric layer has a density in the range of 10 to 30 threads per cm.

In some embodiments, the fabric layer includes at least two layers of fabric attached to one another. In some embodiments, the at least two layers of fabric are laminated to one another. In some embodiments, the at least two layers of fabric are attached to one another by an adhesive.

In some embodiments, the rubber-based material includes a material selected from the group consisting of acrylonitrile butadiene copolymer rubber, EPDM rubber, and chloroprene rubber.

In some embodiments, the rubber-based material includes at least one of a vulcanizing agent, a vulcanizing accelerator, and a softening agent.

In some embodiments, the contact layer of the compressible counter film having a Shore A hardness in the range of 60-90 or 65-75.

In some embodiments, the compressible counter film has a thickness in the range of 0.5 mm to 10 mm, 1 mm to 8 mm, 1 mm to 6 mm, 1 mm to 5 mm, 1 mm to 3 mm, or 1 mm to 2 mm.

In some embodiments, the base layer has a thickness in the range of 0.15 mm to 1 mm.

In some embodiments, the base layer includes a metal layer. In some embodiments, the metal layer includes at least one of aluminum and steel.

In some embodiments, the base layer includes a polymer layer. In some embodiments, the polymer layer includes PET.

In some embodiments, the base layer includes a fabric layer. In some embodiments, the fabric layer includes a material selected from the group consisting of polyester, rayon, and cotton. In some embodiments, the fabric layer includes a woven fabric. In some embodiments, the woven fabric has a density in the range of 10 to 30 threads per cm.

In some embodiments, the fabric layer includes at least two layers of fabric attached to one another. In some embodiments, the at least two layers of fabric are laminated to one another. In some embodiments, the at least two layers of fabric are attached to one another by an adhesive.

In some embodiments, the fabric layer is impregnated with a rubber-based material. In some embodiments, the rubber-based material includes a material selected from the group consisting of acrylonitrile butadiene copolymer rubber, EPDM rubber, and chloroprene rubber. In some embodiments, the rubber-based material includes at least one of a vulcanizing agent, a vulcanization accelerator, an auxiliary vulcanization accelerator, a filler, a reinforcer, a softener, a plasticizer, and an antioxidant.

In some embodiments, the compressible layer is adapted to decrease lateral deformation resulting from pressure applied to the compressible counter film.

In some embodiments, the compressible layer has a thickness in the range of 0.15 mm to 5 mm, 0.15 mm to 4 mm, 0.15 mm to 3 mm, 0.15 mm to 2 mm, or 0.15 mm to 1 mm.

In some embodiments, the compressible layer includes a rubber foam layer. In some embodiments, the rubber foam layer includes a synthetic rubber, in some embodiments, the synthetic rubber includes at least one material selected from the group consisting of acrylonitrile-butadiene copolymer rubber, butadiene rubber, poly-isoprene rubber, butyl rubber, chloroprene rubber, EPDM rubber, and polyurethane rubber.

In some embodiments, the compressible layer is directly attached to the base layer. In some embodiments, the compressible layer is attached to the base layer by at least one of an adhesive and lamination.

In some embodiments, the contact layer includes a rubber-based material. In some embodiments, the rubber based material includes at least one synthetic rubber. In some embodiments, the at least one synthetic rubber includes at least one material selected from the group consisting of acrylonitrile-butadiene rubber (NBR), hydrogenated NBR, butadiene rubber, poly-isoprene rubber, butyl rubber chloroprene rubber (CR), polyurethane rubber, EPDM rubber, polysulfide rubber, and acrylic rubber.

In some embodiments, the rubber-based material further includes at least one of a vulcanizing agent, a vulcanization accelerator, an auxiliary vulcanization accelerator, a filler, a reinforcer, a softener, a plasticizer, and an antioxidant.

In some embodiments, the contact layer includes a compressible rubber based material. In some embodiments, the contact layer has a thickness in the range of 0.1 mm to 5 mm, 0.1 mm to 4 mm, 0.1 mm to 3 mm, 0.1 mm to 2 mm, or 0.1 mm to 1 mm.

In some embodiments, at least one of the at least one male die and the compressible counter film is mounted onto a rotating drum. In some embodiments, the at least one male die is mounted onto a first rotating drum and the compressible counter film is mounted onto a second rotating drum.

In some embodiments, upon application of pressure to the compressible counter film, the compressible layer absorbs the pressure by compressing until the compressible layer is substantially incompressible.

In some embodiments, the substrate includes a fibrous substrate. In some embodiments, the fibrous substrate includes paper. In some embodiments, the paper includes a paper coated by a metal foil. In some embodiments, the paper includes a paper coated by a plastic coating. In some embodiments, the substrate has a thickness in the range of 0.1-1 mm, 0.1 to 0.8 mm, or 0.2 to 0.5 mm. In some embodiments, the substrate has a thickness of 0.3 mm.

In some embodiments, the substrate includes a metal foil. In some embodiments, the metal foil is selected from the group consisting of a copper foil and an aluminum foil. In some embodiments, the metal foil includes a shape memory metal alloy foil. In some embodiments, the metal foil has a thickness in the range of 0.02 mm to 0.2 mm.

In some embodiments, the substrate includes a plastic substrate. In some embodiments, the plastic substrate has a thickness in the range of 0.05 mm to 0.5 mm.

In some embodiments, the system further includes a heating mechanism for applying heat to the plastic substrate during impression of the relief pattern thereon.

According to a further aspect of the present invention there is provided a method for impressing relief pattern on a substrate, the relief pattern including a plurality of line indentations disposed in parallel, the method including:

placing a substrate between at least one male die and a compressible counter film,

wherein the at least one male die includes a contact surface defining the relief pattern, the contact surface including a plurality of line rules disposed in parallel,

and wherein the compressible counter film includes:
a base layer;
a contact layer disposed opposite the contact surface of the at least one male die and spaced therefrom; and
a compressible layer disposed between the base layer and the contact layer and attached thereto,

the contact layer being featureless in a region thereof opposing the relief pattern on the at least one male die; and

moving the at least one male die and the compressible counter film towards one another such that the at least one male die engages a first broad surface of the substrate and the contact layer of the compressible counter film engages an opposing broad surface of the substrate so as to impress the relief pattern on the substrate.

In some embodiments, the relief pattern impressed on the substrate includes a plurality of line indentations disposed in parallel. In some embodiments, each of the plurality of line indentations has a height in the range of 0.01 mm to 0.5 mm, 0.01 mm to 0.3 mm, 0.01 mm to 0.2 mm, 0.01 mm to 0.1 mm, 0.01 mm to 0.08 mm, or 0.01 to 0.05 mm.

In some embodiments, moving includes pressing portions of the substrate into gaps defined between the plurality of line rules. In some embodiments, pressing portions of the substrate includes pressing the portions of the substrate into the gaps to a depth of at least 10 micron, at least 20 microns, at least 50 microns, at least 100 microns, or at least 250 microns. In some embodiments, pressing portions of the substrate includes pressing the portions of the substrate into the gaps to a depth of not more than 1.5 mm, not more than 1.2 mm, not more than 1 mm, not more than 800 microns, or not more than 500 microns.

In some embodiments, the substrate includes a fibrous substrate. In some embodiments, the fibrous substrate includes paper. In some embodiments, the paper includes a paper coated by a metal foil. In some embodiments, the paper includes a paper coated by a plastic coating. In some embodiments, the substrate has a thickness in the range of 0.1-1 mm, 0.1 to 0.8 mm, or 0.2 to 0.5 mm. In some embodiments, the substrate has a thickness of 0.3 mm.

In some embodiments, the substrate includes a metal foil. In some embodiments, the metal foil is selected from the group consisting of a copper foil and an aluminum foil. In some embodiments, the metal foil includes a shape memory metal alloy foil. In some embodiments, the metal foil has a thickness in the range of 0.02 mm to 0.2 mm.

In some embodiments, the substrate includes a plastic substrate. In some embodiments, the plastic substrate has a thickness in the range of 0.05 mm to 0.5 mm.

In some embodiments, the method further includes applying heat to the plastic substrate during impression of the relief pattern thereon.

According to yet a further aspect of the present invention there is provided a method for producing a rounded fold in a substrate, the method including:

placing a substrate between at least one male die and a compressible counter film,

wherein the at least one male die includes a contact surface including a plurality of line rules disposed in parallel,

and wherein the compressible counter film includes:
a base layer;
a contact layer disposed opposite the contact surface of the at least one male die and spaced therefrom; and
a compressible layer disposed between the base layer and the contact layer and attached thereto,

the contact layer being featureless in a region thereof opposing the relief pattern on the at least one male die;

moving the at least one male die and the compressible counter film towards one another such that the at least one male die engages a first broad surface of the substrate and the contact layer of the compressible counter film engages an opposing broad surface of the substrate so as to impress a plurality of line indentations, disposed in parallel, on the substrate; and

folding the substrate along the plurality of line indentations, thereby to form the rounded fold.

In some embodiments, each of the plurality of line indentations has a height in the range of 0.01 mm to 0.5 mm, 0.01 mm to 0.3 mm, 0.01 mm to 0.2 mm, 0.01 mm to 0.1 mm, 0.01 mm to 0.08 mm, or 0.01 to 0.05 mm.

In some embodiments, moving includes pressing portions of the substrate into gaps defined between the plurality of line rules. In some embodiments, pressing portions of the substrate includes pressing the portions of the substrate into the gaps to a depth of at least 10 micron, at least 20 microns, at least 50 microns, at least 100 microns, or at least 250 microns. In some embodiments, pressing portions of the substrate includes pressing the portions of the substrate into the gaps to a depth of not more than 1.5 mm, not more than 1.2 mm, not more than 1 mm, not more than 800 microns, or not more than 500 microns.

In some embodiments, the substrate includes a fibrous substrate. In some embodiments, the fibrous substrate includes paper. In some embodiments, the paper includes a paper coated by a metal foil. In some embodiments, the paper includes a paper coated by a plastic coating. In some embodiments, the substrate has a thickness in the range of 0.1-1 mm, 0.1 to 0.8 mm, or 0.2 to 0.5 mm. In some embodiments, the substrate has a thickness of 0.3 mm.

In some embodiments, the substrate includes a metal foil. In some embodiments, the metal foil is selected from the group consisting of a copper foil and an aluminum foil. In some embodiments, the metal foil includes a shape memory metal alloy foil. In some embodiments, the metal foil has a thickness in the range of 0.02 mm to 0.2 mm,

In some embodiments, the substrate includes a plastic substrate. In some embodiments, the plastic substrate has a thickness in the range of 0.05 mm to 0.5 mm.

In some embodiments, the method further includes applying heat to the plastic substrate during impression of the relief pattern thereon.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. Throughout the drawings, like-referenced characters are used to designate like elements.

In the drawings:

FIG. 1A is a perspective view illustration of an embodiment of an inventive multi-orifice nozzle for creating a rule die including multiple rule dies disposed in parallel according to an embodiment of the teachings herein;

FIGS. 1B, 1C, 1D, and 1E are, respectively, front, side, back, and bottom plan view illustrations of the multi-orifice nozzle of FIG. 1A;

FIGS. 1F and 1G are sectional illustrations of the multi-orifice nozzle of FIG. 1A, FIG. 1F taken along section lines F-F in FIG. 1D, and FIG. 1G taken along section lines G-G in FIG. 1C;

FIG. 2 provides a schematic diagram with relevant elements of a portion of a prior-art rotary rule-writing system suitable for use with the multi-orifice nozzle of FIGS. 1A to 1G;

FIG. 3 provides a schematic diagram of an exemplary portion of a prior-art Cartesian coordinate rule-writing system suitable for use with the multi-orifice nozzle of FIGS. 1A to 1G;

FIG. 4 provides an schematic diagram of an exemplary embodiment of a prior-art drawing-head suitable for use with the multi-orifice nozzle of FIGS. 1A to 1G;

FIG. 5 schematically illustrates a prior-art pressure actuator which may form part of a rule-writing system and is suitable for use with the multi-orifice nozzle of FIGS. 1A to 1G;

FIGS. 6A, 6B, 6C and 6D are side plan view schematic illustrations of multiple embodiments of a rule die created using a multi-orifice nozzle according to an embodiment of the teachings herein;

FIGS. 7A and 7B are schematic cross-sectional diagram of two embodiments of an inventive die and counter die system for impressing a relief pattern on a substrate, the die including multiple parallel line rules, in accordance with aspects of the present invention;

FIGS. 8A, 8B, and 8C are schematic cross-sectional diagram of three embodiments of compressible counter films, usable in the systems of FIGS. 7A and 7B;

FIGS. 9A and 9B are a schematic illustration of a substrate impressed with a relief pattern using the rule die of FIG. 6A and the system of FIG. 7B, in a spread out orientation and when folded along the line indentations; and

FIG. 10 provides a partial screenshot of a characterization of the relief pattern of the substrate of FIG. 9A.

### DESCRIPTION OF THE PREFERRED EMBODIMENTS

The present invention relates to systems for drawing rule dies and, more particularly, to a system including a multi-orifice nozzle for drawing multiple parallel rule dies, and to die and counter die systems using such multiple parallel rule dies.

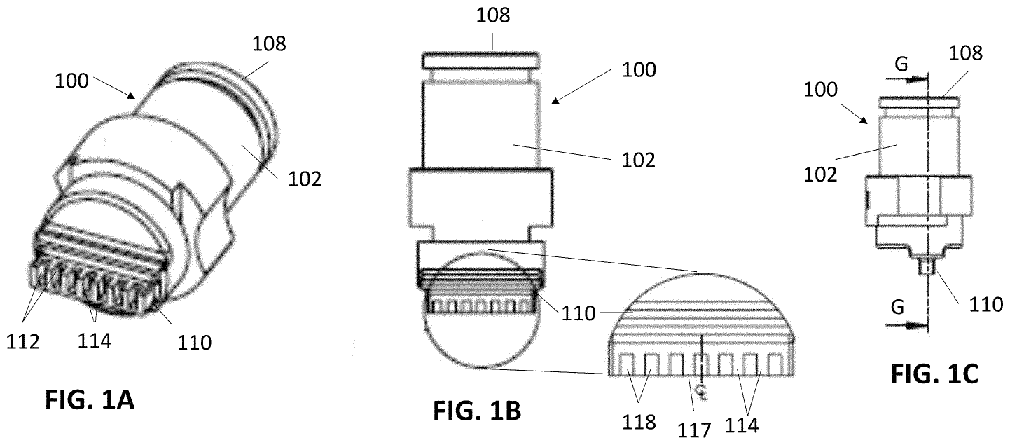

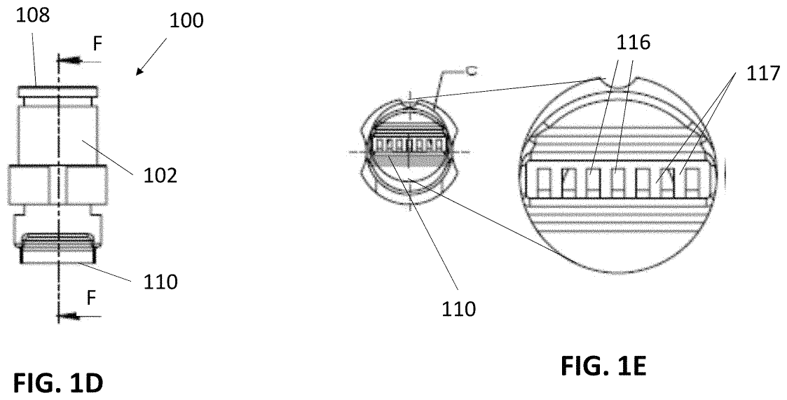

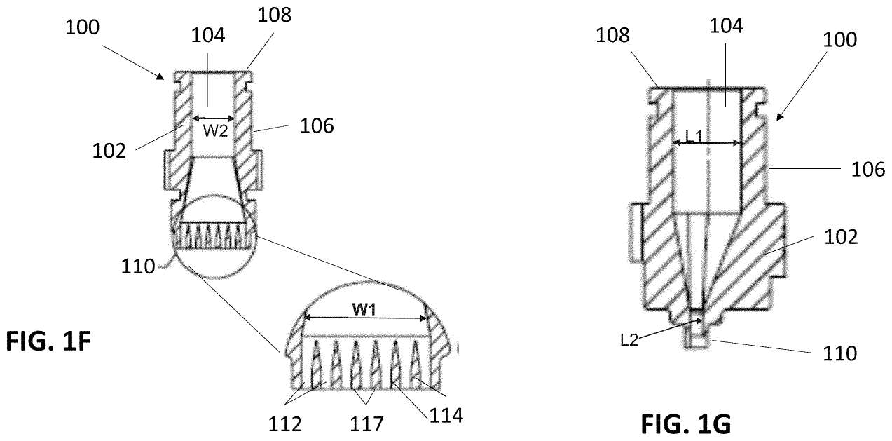

Reference is now made to FIG. 1A, which is a perspective view illustration of an embodiment of an inventive multi-orifice nozzle 100 for creating a rule die including multiple rule dies disposed in parallel according to an embodiment of the teachings herein, to FIGS. 1B, 1C, 1D, and 1E, which are, respectively, front, side, back, and bottom plan view illustrations of the multi-orifice nozzle 100, and to FIGS. 1F and 1G, which are sectional illustrations of the multi-orifice nozzle 100, FIG. 1F taken along section lines F-F in FIG. 1D, and FIG. 1G taken along section lines G-G in FIG. 1C.

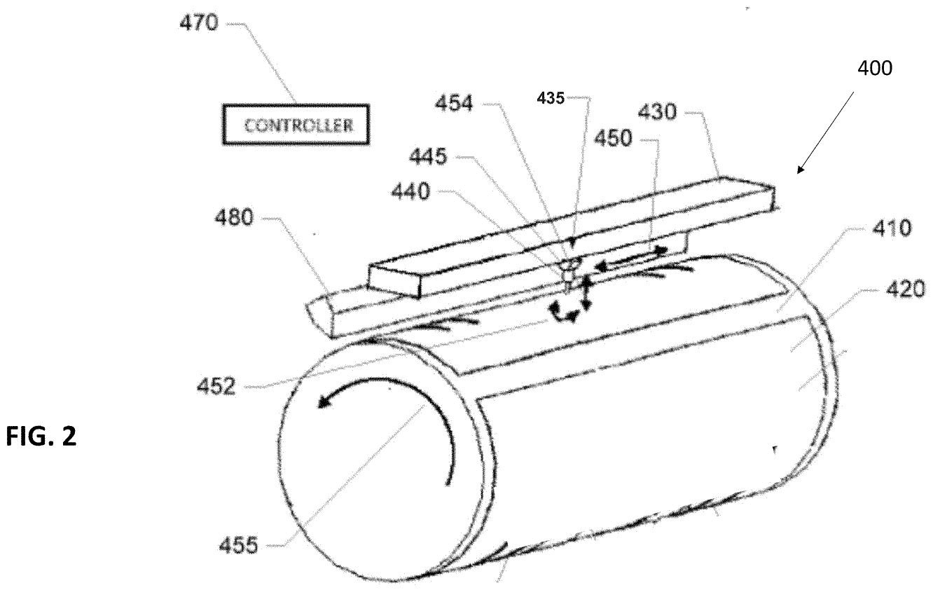

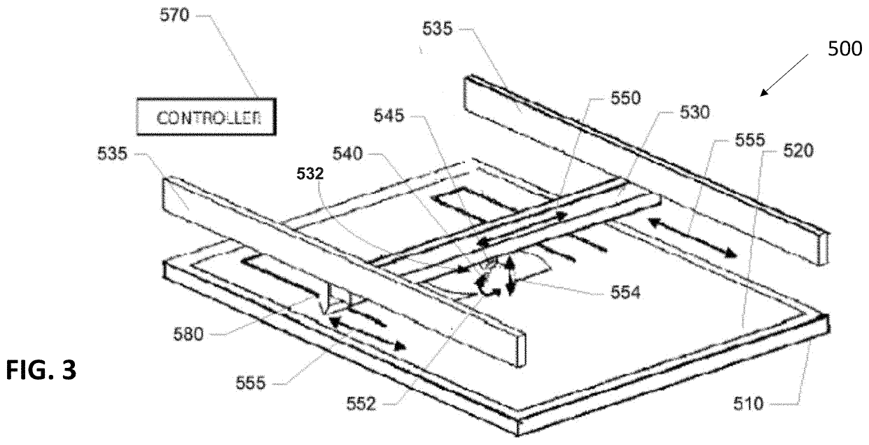

As seen, nozzle 100 includes a nozzle body 102 having a hollow bore 104 formed therein. The nozzle body 102 has a generally cylindrical exterior surface 106 including multiple indentations and protrusions, which is structured and adapted for connection to a rule drawing system, such as the rule drawing systems described hereinbelow with reference to FIGS. 2 and 3. The arrangement and sizing of the indentations and protrusions may be specific to the rule drawings system to which nozzle 100 is connectable.

Nozzle body 102 terminates at one end thereof at a connector end 108 at which fluid may be received by the bore 104, and at an opposite end in a nozzle tip 110 including a plurality of orifices 112 arranged in a single straight line. Each of the orifices 112 is in fluid flow communication with bore 104, and each pair of adjacent orifices 112 is separated by a common wall 114, the common wall terminating at a bottom surface 117, as seen clearly in FIG. 1F.

Nozzle 100 may include any suitable number of orifices 112. In some embodiments, the number of orifices is in the range of 2 to 30, 2 to 28, 2 to 25, 2 to 22, 2 to 20, 2 to 18, or 2 to 15.

In some embodiments, the distance between two adjacent orifices 112 is in the range of 0.3 mm to 6.0 mm, 0.5 mm to 5.5 mm, 0.5 mm to 5.0 mm, 0.5 mm to 4.5 mm, 0.5 mm to 4.0 mm, 0.5 mm to 3.5 mm, 0.5 mm to 3.0 mm, 0.5 mm to 2.5 mm, or 0.5 mm to 2.0 mm.

In some embodiments, the width of a common wall 114 is in the range of 0.3 mm to 6.0 mm, 0.5 mm to 5.5 mm, 0.5 mm to 5.0 mm, 0.5 mm to 4.5 mm, 0.5 mm to 4.0 mm, 0.5 mm to 3.5 mm, 0.5 mm to 3.0 mm, 0.5 mm to 2.5 mm, or 0.5 mm to 2.0 mm.

In some embodiments, the cumulative width of all the orifices 112 and common walls 114, indicated by W1, is greater than the width of bore 104 at connector end 108, indicated by W2. In such embodiments, the width of bore 104 is outwardly tapered, at least in a portion thereof, so as to be in fluid flow connection with all of orifices 112, as seen in FIG. 1F.

As seen in FIG. 1G, in some embodiments, the cross-sectional width of each individual orifice 112, indicated by L2, and consequently the smaller dimension of the line of orifices 112, is smaller than the width of bore 104 at connector end 108, indicated by L1. In such embodiments, bore 104 is longitudinally inwardly tapered, so as to direct fluid passing through the bore to the orifices 112.

In some embodiments, illustrated clearly in FIG. 1E, each of orifices 112 may include a bottom opening 116 which is substantially parallel to bottom surfaces 117 of the common walls 114. Each of orifices 112 may also include a side opening 118, in fluid communication with bottom opening 116, the side opening 118 disposed perpendicularly to bottom surfaces 117, and in parallel to said straight line along which the orifices 112 are arranged, as seen in FIG. 1B. In some embodiments, the bottom opening may be obviated.

In some embodiments, each orifice 112, and specifically each opening 116 and 118 has a width in the range of 0.5 mm to 1.0 mm, 0.6 mm to 0.9 mm, 0.65 mm to 0.85 mm, 0.7 mm to 0.85 mm, or 0.75 mm to 0.85 mm.

In some embodiments, the length of bottom opening 116 is in the range of 1.1 mm to 1.5 mm, 1.15 mm to 1.45 mm, 1.2 mm to 1.4 mm, or 1.25 mm to 1.35 mm.

In some embodiments, the ratio of the length of bottom opening 116 to the width of orifice 112 and of bottom opening 116 is in the range of 1 to 3, 1.1 to 2.7, 1.2 to 2.5, 1.4 to 2,4, 1.5 to 2.3, 1.7 to 2.1, 1.8 to 2, or 1.8 to 1.9.

In some embodiments, the height of side opening 118 is in the range of 1.1 mm to 1.5 mm, 1.15 mm to 1.45 mm, 1.2 mm to 1.4 mm, or 1.25 mm to 1.35 mm.

In some embodiments, the ratio of the height of side opening 118 to the width of orifice 112 and of side opening 118 is in the range of 1 to 3, 1.1 to 2.7, 1.2 to 2.5, 1.4 to 2.4, 1.5 to 2.3, 1.7 to 2,1, 1,8 to 2, or 1.8 to 1.9.

As described in further detail hereinbelow, in use, a viscous fluid material, such as polymeric resin, is extruded from each orifice 112 at a predetermined flow rate, while the nozzle 100 is in motion, thereby forming a line of resin. The line of resin may then be cured to form a line rule for a male die,

In some embodiments, the side opening 118 of each orifice 112 may have any suitable shape, and in some embodiments has a shape corresponding to a desired shape of a line formed from resin extruded through the opening. For example, the side opening may have a rectangular shape, a trapezoidal shape, or an arched or arcuate shape. In some embodiments, the side openings 118 of all the orifices 112 in the nozzle may have the same shape. In other embodiments, the side openings 118 of different orifices 112 may have different shapes.

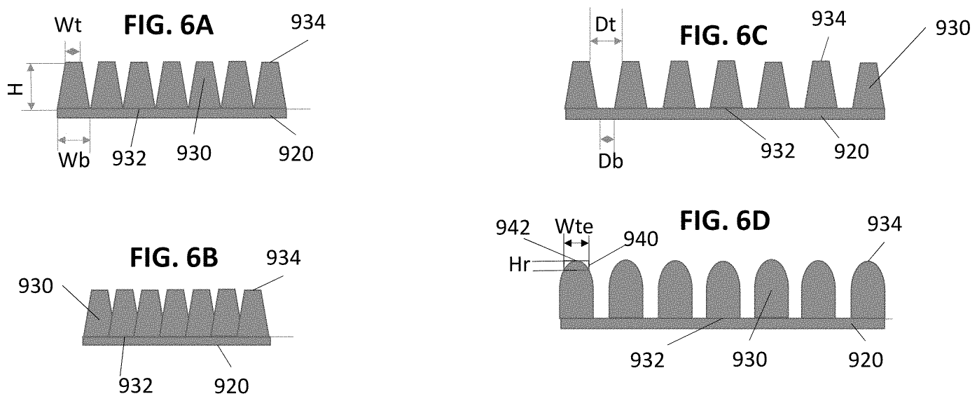

In some embodiments, the flow rate of the viscous material, when passing through nozzle 100, is greater at orifices 112 located at the center of the line of orifices than at orifices 112 located at ends of the line of orifices, which may result in line rules being extruded from different orifices of the nozzle having different dimensions. To compensate for this, in some embodiments, orifices 112 located at ends of the line of orifices have a greater cross section than orifices 112 located at the center of the line. FIG. 2 provides a schematic diagram with relevant elements of a portion of a rule-writing system such as a rotary system 400. Rotary system 400 may be used with the multi-orifice nozzle 100 described hereinabove with reference to FIGS. 1 A to 1G, for drawing a plurality of parallel rules on a surface of a die base or substrate 420. The rules and their functionality are described hereinbelow with reference to FIGS. 6A to 10.

Rotary system 400 may include a drum 410 on which die base 420 may be positioned. Die base 420 may be associated with or joined to the drum 410 by means of adhesion or gripping.

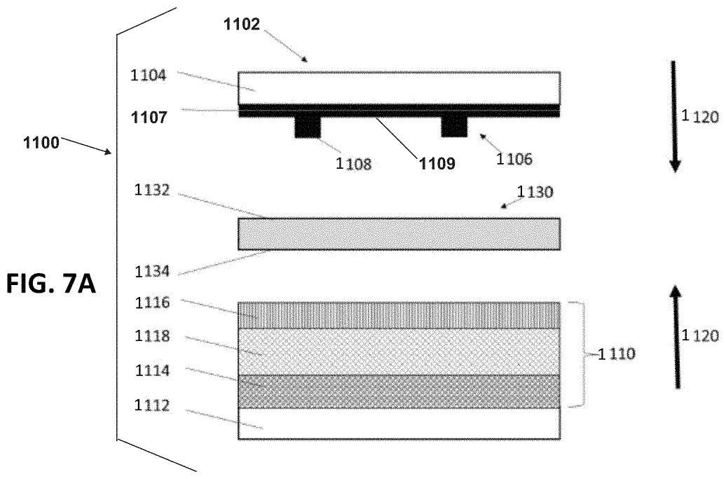

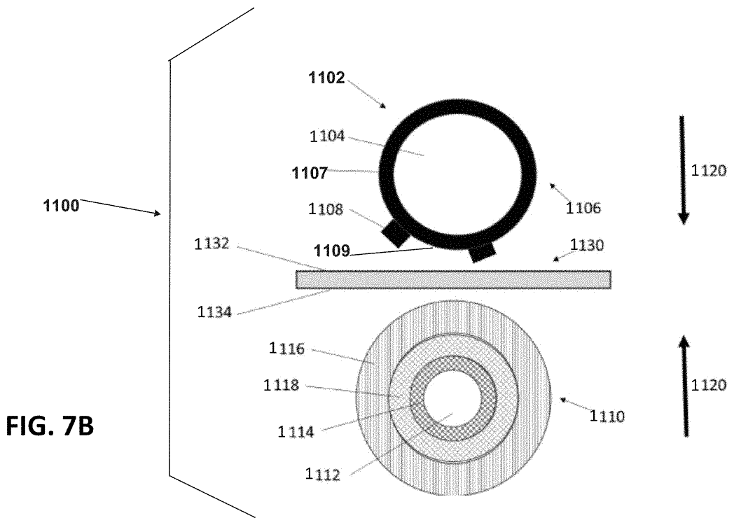

In some embodiments, die base 420 may be removed from drum 410 after rules are produced. In other exemplary embodiments, die base 420 may be left on the drum 410, to be used for impressing a relief pattern onto a substrate in a rotary impressing system as described hereinbelow with reference to FIG. 7B. In some embodiments, rotary system 400 includes at least one additional drum (not shown) that is adapted and positioned to serve as a counter-die. Such a system may be similar to that described hereinbelow with reference to FIG. 7B.

In some embodiments, the die base 420 may be made of a flexible film. The flexible film may include at least one type of polymer such as a polyethylene terephthalate (PET). Exemplary polymers include polyester, polyamide, and polycarbonate. Metallic films or foils such as aluminum foil or copper foil may also be suitable.

Rotary system 400 further includes one or more rule-drawers. The rule-drawer may include a drawing head 435, a controller 470, and one or more rails 430. Drawing head 435 may include a nozzle arrangement 440, which may be include a nozzle 100 as described hereinabove with reference to FIGS. 1A to 1G, and at least one canister 445 fluidly associated with arrangement 440. Arrangement 440 may be associated with rail 430. In some embodiments, arrangement 440 may slide along rail 430V in some embodiments, canister 445 may also be associated with rail 430. In some embodiments, canister 445 may be independent of rail 430. Canister 445 may contain a rule-forming formulation for discharging under pressure by arrangement 440, so as to draw the parallel rules. In some embodiments, such pressure may be induced or delivered by a pneumatic system, or by a positive displacement system.

In some embodiments, the canister 445 and arrangement 440 may be associated with, or controlled by, a motor for moving canister 445 and/or arrangement 440 back and forth on rail 430 in a direction indicated by arrow 450. In addition, arrangement 440 may be adapted to rotate in the directions indicated by arrows 452. Arrangement 440 may also move up and down in the directions indicated by arrows 454. In some embodiments, drawing-head 435 may form a single unit, while in other embodiments, nozzle arrangement 440 and canister 445 may be moved independently from one other.

Drum 410 may be adapted to rotate in a counter-clockwise direction, as indicated by arrow 455. Optionally, drum 410 may rotate in a direction opposite to the direction indicated by arrow 455 (i.e., clockwise), or may rotate in both directions. Drum 410 may also be configured to move laterally in relationship to the rail. Controller 470 may control and coordinate the movement and operations of the different modules or elements, as well as the operations of rotary system 400. Controller 470 may control the rotation of drum 410, and the movement of nozzle 440 and canister 445. Controller 470 may also instruct and control arrangement 440 and canister 445 so as to deposit resin on die base 420 to produce a desired or pre-defined layout or pattern of the parallel rules.

The resin output by arrangement 440 may be hardened after and/or while the drawing is being performed. The hardening may be accomplished by a curing or hardening apparatus, such as a curing lamp 480.

Curing lamp 480 may radiate energy that can cause the drawn resin to harden and/or adhere. The radiated energy may include ultraviolet (UV) light, visible light, heat, etc.

The type of energy irradiated by curing lamp 480 generally depends on the type of resin and the hardening characteristics of that material. For example, when the resin is a thermosetting material, heat may be applied by curing lamp 480. When the resin is a thermoplastic material, curing lamp 480 may cool the material in order to harden it. When the resin includes a photo-initiator, curing lamp 480 may provide UV lighting to cure the resin.

Curing lamp 480 may be positioned adjacent to the nozzle arrangement 440 such that the resin may be hardened immediately after it is drawn. In other exemplary embodiments curing lamp 480 may be positioned at a distance from the nozzle arrangement 440.

FIG. 3 provides a schematic diagram of an exemplary portion with relevant elements of a flat rule writing system suitable for use with the multi-orifice nozzle of FIGS. 1A to 1G, such as a Cartesian coordinate system 500. System 500 may be used for drawing multiple parallel rules on the surface of a die base 520 that may be positioned on a flat substrate 510. Die base 520 may be substantially similar to die base 420 described hereinabove with reference to FIG. 2.

System 500 may include at least one rule-drawer. In some embodiments, the rule-drawer may include a drawing-head 532, a controller 570, and one or more rails 530. Drawing-head 535 may include a nozzle arrangement 540, which may be include a nozzle 100 as described hereinabove with reference to FIGS. 1A to 1G, and at least one canister 545 associated with, or fluidly coupled to, nozzle arrangement 540.

The multiple parallel rules may be drawn by nozzle arrangement 540. Nozzle arrangement 540 may be associated with a motor powering nozzle arrangement 540 to traverse along rail 530 in the directions of arrow 550, for example. Nozzle arrangement 540 may be adapted to rotate in directions illustrated by arrows 552 and/or 554. Rail 530 may be situated between two rails 535, substantially perpendicular to rail 530 and may be adapted to travel in the directions of arrow 555, for example.

Controller 570 may be adapted to control the movement of the different modules of system 500. For example, controller 570 may control nozzle arrangement 540, rail 530, and canister 545. In some embodiments, system 500 may further include a curing lamp 580, such as a UV lamp, adapted to cure the multiple parallel rules such that the rules firmly adhere to the surface of die base 520. Curing lamp 580 may be substantially similar to curing lamp 480, described hereinabove with reference to FIG. 2.

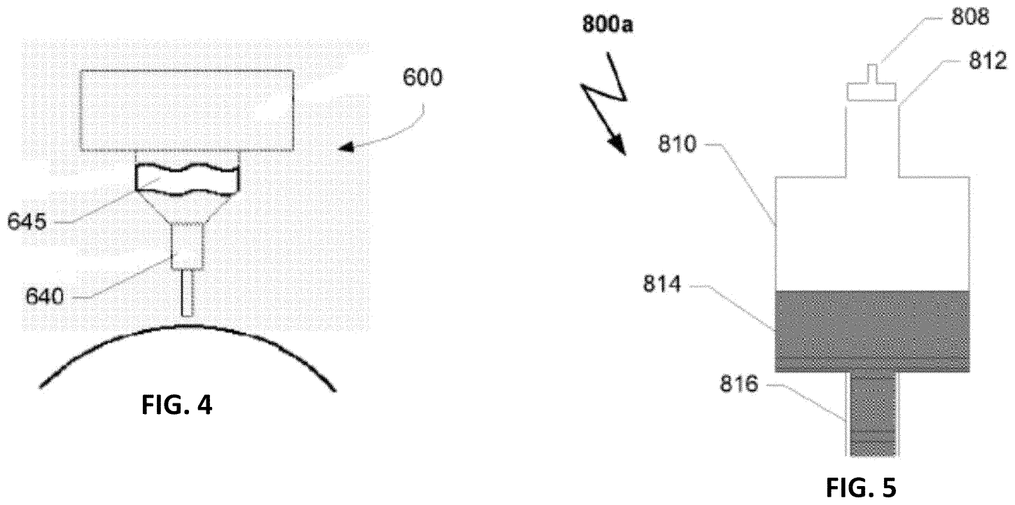

FIG. 4 provides a schematic diagram of an exemplary embodiment of a prior art drawing-head 600, suitable for use with the multi-orifice nozzle of FIGS. 1A to 1G. Drawing-head 600 may include a nozzle arrangement 640, for example including multi-orifice nozzle 100 of FIGS. 1A to 1G, for depositing multiple parallel continuous lengths (“beads”) of resin. Nozzle arrangement 640 may be associated with or fluidly coupled to a canister 645, as described hereinabove with reference to FIGS. 2 and 3.

FIG. 5 schematically illustrates a prior-art pressure actuator 800a which may form part of a rule-writing system and is suitable for use with the multi-orifice nozzle 100 of FIGS. 1A to 1G. Pressure actuator 800a may be an air-pump actuator having a canister 810 adapted to contain a resin 814. Canister 810 may have an output 816 that fluidly couples canister 810 to a nozzle, such as the multi-orifice nozzle 100 of FIGS. 1A to 1G. The canister may have an input 812 through which air may be compressed and thus pneumatically drive out resin 814, through output 816, via a nozzle (not shown) so as to draw rules. The air may be compressed by a piston 808, which may be controlled by a controller.

Reference is now made to FIGS. 6A-6D, which are side plan view schematic illustrations of multiple embodiments of a rule die created using a multi-orifice nozzle, such as nozzle 100 of FIGS. 1A to 1G.

As seen in FIGS. 6A to 6D, the rule die includes a die base 920, having a plurality of line rules 930, disposed in parallel to one another, disposed thereon. Each rule 930 includes a rule base 932 and a rule tip 934. Die base 920 may be substantially similar to die bases 420 and 520 described hereinabove with reference to FIGS. 2 and 3. As described in further detail hereinbelow with reference to FIGS. 7A to 10, rule tips 934 form part of a contact surface which impinges upon a substrate, thereby to impress a relief pattern thereon.

The line rules 930 may be drawn onto die base 920 by a rule drawing system, such as the systems described hereinabove with reference to FIGS. 2 and 3, including a multi-orifice nozzle, such as nozzle 100 described hereinabove with reference to FIGS. 1A to 1G. More specifically, the rules 930 may be drawn by extruding a viscous fluid material, such as a polymeric resin, from nozzle 100 during motion thereof above die base 920.

The polymeric resin used for drawing the rules may be any suitable polymeric resin, for example as described in PCT Patent Publication WO/2015/155685, which is incorporated by reference as if fully set forth herein.

The number of rules 930 drawn onto the die base 920 typically corresponds to the number of orifices in the multi-orifice nozzle used for drawing the rules, and may be in the range of 2 to 30, 2 to 28, 2 to 25, 2 to 22, 2 to 20, 2 to 18, or 2 to 15.

The rules 930 may have any suitable cross-sectional shape. For example, the rules may be trapezoidal, as illustrated in FIGS. 6A to 6C, arched or arcuate, as illustrated in FIG. 6D, or may be rectangular or triangular. In some embodiments, all the rules 930 extruded from the same nozzle have the same cross-sectional shape, as illustrated in FIGS. 6A to 6D. In other embodiments, different rules 930 extruded from the nozzle may have different cross-sectional shapes, for example if different orifices have different opening shapes, as described hereinabove.

The shape of a rule 930 may be determined or influenced by the shape of the opening of the orifices used to draw the rules, as described hereinabove with reference to FIGS. 1A to 1G, the specific polymeric resin used to the draw the rules and a degree of viscosity thereof, and the process used to draw the rules, for example whether curing occurs as the rules are being drawn or at a later stage, and the height of the nozzle above the die base 920 when drawing the rules.

The specific dimensions of each rule 930, as well as the distances between the rules, are affected by the shape of the opening of the orifice used to draw the rule, as described hereinabove with reference to FIGS. 1A to 1G, the specific polymeric resin used to the draw the rules and a degree of viscosity thereof, and the process used to draw the rules, for example whether curing occurs as the rules are being drawn or at a later stage, and the height of the nozzle above the die base 920 when drawing the rules.

In some embodiments, the plurality of line rules have substantially the same width, where a difference in widths between any two rules 930 is not more than 50 micrometers, not more than 40 micrometers, not more than 30 micrometers, or not more than 20 micrometers.

In some embodiments, the width Wb of each rule 930 at the base 932 thereof is in the range of 0.3 mm to 5.0 mm, 0.3 mm to 4.5 mm, 0.3 mm to 4.0 mm, 0.3 mm to 3.5 mm, 0.3 mm to 3.0 mm, 0.4 mm to 2.5 mm, or 0.5 mm to 2.0 mm.

In some embodiments, the width Wt of each rule 930 at the tip 934 thereof is in the range of 0.1 mm to 5.0 mm, 0.1 mm to 4.5 mm, 0.1 mm to 4.0 mm, 0.1 mm to 3.5 mm, 0.1 mm to 3.0 mm, 0.1 mm to 2.5 mm, 0.2 mm to 2.0 mm, 0.3 mm to 1.5 mm, or 0.3 mm to 1.0 mm.

In some embodiments, the width of the tip is defined by width of the planar portion of the tip which is parallel to the rule base. In other embodiments, particularly in embodiments in which the tip terminates at a single point, such as when the rule 930 has a triangular or arcuate cross section, the effective width of the rule tip is calculated using a circumscribing rectangle, as illustrated in FIG. 6D. Specifically, a rectangle 940 having a height Hr in the range of 0.06 mm to 0.25 mm, or 0.1 mm to 0.2 mm is used to enclose the tip of the rule, such that a side 942 of the rectangle engages the highest point of the rule. The effective width of the rule, indicated by Wte, is defined to be equal to the width of side 942.

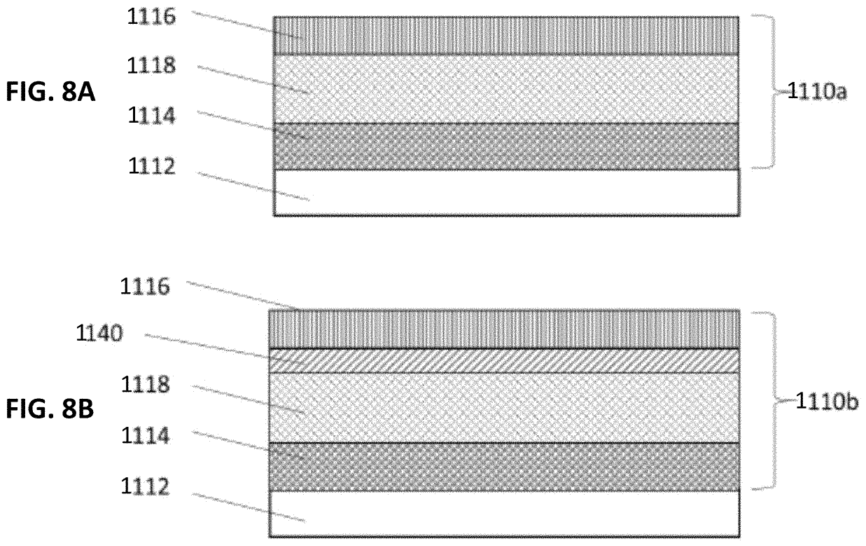

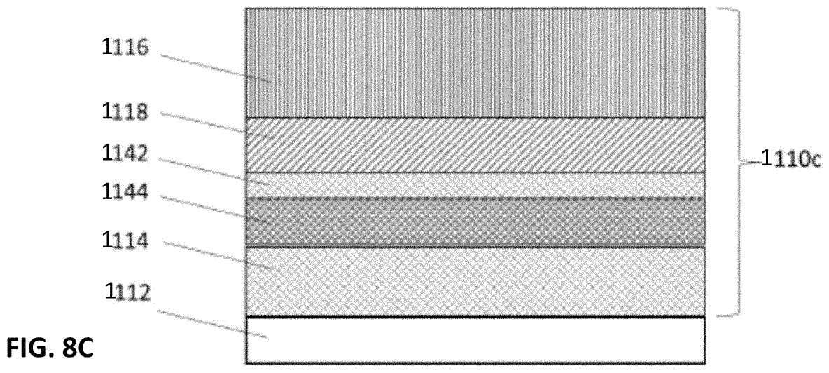

The exact height Hr suitable for calculating the Wte in a specific system depends on the properties of the die base, the properties of the polymeric resin from which the rule is made, on the properties of the compressible counter film (described with reference to FIGS. 7A to 8C), and on the amount of pressure applied when using the rule to impress a relief pattern onto a substrate. In some embodiments, Hr equals 0.06 mm. In some embodiments, Hr equals 0.1 mm. In some embodiments, Hr equals 0.12 mm, In some embodiments, Hr equals 0.15 mm, In some embodiments, Hr equals 0.18 mm. In some embodiments, Hr equals 0.2 mm. In some embodiments, Hr equals 0.22 mm. In some embodiments, 11r equals 0.25 mm.

In some embodiments, the plurality of line rules have substantially the same height, a difference in heights between any two rules 930 is not more than 50 micrometers, not more than 40 micrometers, not more than 30 micrometers, or not more than 20 micrometers.

In some embodiments, the height H of each rule 930 is in the range of 0.3 mm to 5.0 mm, 0.3 mm to 4.5 mm. 0.3 mm to 4.0 mm, 0.3 mm to 3.5 mm, 0.3 mm to 3.0 mm, 0.4 mm to 2.5 mm, or 0.5 mm to 2.0 mm.

In some embodiments, the each pair of adjacent line rules 930 are substantially equidistant from one another, a difference in distances between two pairs of rules 930 is not more than 50 micrometers, not more than 40 micrometers, not more than 30 micrometers, or not more than 20 micrometers.

In some embodiments, the distance Db between two adjacent rules, at base 932 thereof, is in the range of 0 mm to 5.0 mm, 0.1 mm to 4.5 mm, 0.2 mm to 4.0 mm, 0.3 mm to 3.5 mm, 0.3 mm to 3.0 mm, 0.4 mm to 2.5 mm, or 0.5 mm to 2.0 mm. In some embodiments, such as in the embodiment of FIG. 6A, a distance Db of 0 mm between the bases 932 of the rules 930 is formed by single point engagement at the base of two adjacent rules. In other embodiments, such as the embodiment of FIG. 6B, the bases 932 of the rules overlap, or merge together, to form a continuous rule surface from which protrude the rules 930.

In some embodiments, the distance Dt between two adjacent rules, at tip 934 thereof, is in the range of 0.2 mm to 4.0 mm, 0.3 mm to 3.5 mm, 0.4 mm to 3.5 mm, 0.5 mm to 3.0 mm, 0.6 mm to 2.5 mm, or 0.7 mm to 2.0 mm. In embodiments in which the tip terminates at a single point, such as when the rule 930 has a triangular or arcuate cross section, it is assumed that the width Wt is equal to 0.1 mm surrounding the highest point of the rule, and the distance Dt is measured from the end of the width of the tip of one rule to the beginning of the width of the tip of an adjacent rule.

Reference is now made to FIGS. 7A and 7B, which are schematic cross-sectional diagram of two embodiments of an inventive die and counter die system for impressing a relief pattern on a substrate, the die including multiple line rules disposed in parallel to one another, in accordance with aspects of the present invention.

As seen in FIGS. 7A and 7B, a system 1100 for impressing a relief pattern on a substrate includes a male die 1102 mounted onto a system base 1104, the male die having a contact surface 1106 defining the relief pattern, to be impressed onto a substrate as described hereinbelow. The system base 1104 may be a flat, or planar base, as illustrated in FIG. 7A, or may be a rotating drum, as illustrated in FIG. 7B.

In the illustrated embodiment, the male die 1102 comprises a die base 1107, similar to die base 920 described hereinabove with reference to FIGS. 6A to 6D, and a plurality of line rules 1108, disposed in parallel to one another and separated by gaps 1109, the line rules 1108 adapted to impress onto a substrate multiple parallel indentation lines as the relief pattern.

In some embodiments, the rules 1108 are formed on male die 1102 using the inventive multi-orifice nozzle of FIGS. 1A to 1G, for example used in a rule drawing system, substantially as described hereinabove with reference to FIGS. 2 to 5.

However, in some embodiments, the male die 1102 and/or the portion thereof defining the relief pattern may be formed of metal, a polymeric material, or any other suitable material, and may be created using any suitable mechanism, including ink jet printing, three dimensional printing, or using Surface Adhesive Rule Technology as described in PCT application publication number WO2011/145092 filed May 17, 2011 and entitled “Method and System for Surface Adhesive Rule Technology”, in PCT application publication number WO2015/155685 filed Apr. 7, 2015 and entitled “Polymeric Rule Die, and Formulations Therefor”, and in PCt application publication number WO2013/030828 filed Sep. 3, 2012 and entitled “Method and System for a Multiple Orifice Nozzle”, all of which are incorporated by reference as if fully set forth herein.

Disposed opposite male die 1102, and spaced therefrom, is a multi-layered compressible counter film 1110 mounted on a film base 1112. As explained in further detail hereinbelow with reference to FIGS. 8A to 8C, the compressible counter film includes at least a base layer 1114 adjacent film base 1112, a contact layer 1116, disposed opposite the contact surface 1106 of male die 1102, and a compressible layer 1118 disposed between base layer 1114 and contact layer 1116.

The compressible counter film 1110 is featureless, or a plain flat film, in an area opposing the relief pattern of the male die 1102. In some embodiments, the compressible counter film 1110, or at least contact layer 1116, is completely featureless, whereas in other embodiments the compressible counter film 1110 may include one or more features, whether features of a male die, a female die, textures, or any other features, in an area which does not oppose the relief pattern of the male die 1102.

The film base 1112 may be a flat, or planar base, as illustrated in FIG. 7A, or may be a rotating drum, as illustrated in FIG. 7B.

In some embodiments, in which bases 1104 and 1112 are both rotating drums, as illustrated in FIG. 7B, rotating drums 1104 and 1112 may have the same diameter.

A compression mechanism is functionally associated with male die 1102 and with compressible counter film 1110, or with bases 1104 and 1112 thereof, and is adapted to move the male die 1102 and the compressible counter film 1110 towards one another, as indicated by arrows 1120. The compression mechanism may be any suitable compression mechanism, such as a gear-based mechanism or a hydraulic mechanism.

In use, a substrate 1130 is placed between contact surface 1106 male die 1102 and contact layer 1116 of compressible counter film 1110, and the compression mechanism moves male die 1102 and compressible counter film. 1110 towards one another, such that the male die engages a first surface 1132 of the substrate and the contact layer 1116 of the compressible counter film 1110 engages an opposing surface 1134 of the substrate so as to impress the relief pattern defined by contact surface 1106 on the substrate 1130.

It is a particular feature of the teachings herein that the compressible counter film 1110 is sufficiently compressible so as to push the substrate 1130 into gaps 1109 to at least part of the height of the rules. In some embodiments, the substrate 1130 is pushed into gaps 1109 to a depth of at least 10 micron, at least 20 microns, at least 50 microns, at least 100 microns, or at least 250 microns. In some embodiments, the substrate 1130 is pushed into gaps 1109 to a depth of not more than the height of the rules 1108. In some embodiments, the substrate 1130 is pushed into gaps 1109 to a depth of not more than 1.5 mm, not more than 1.2 mm, not more than 1 mm, not more than 800 microns, or not more than 500 microns.

In the prior art, when impressing a crease line onto a substrate, arcuate rule shapes are considered less desirable than trapezoidal, rectangular, or other angular rule shapes, as the arcuate contour of the rule results in a less well defined crease line. The Inventors have surprisingly found that when using a die including multiple line rules disposed in parallel, such as rule die 1102, rules having an arcuate cross section provide a clearer, better defined relief pattern on the substrate 1130.

Without wishing to be bound by theory, the Inventors believe that the arcuate cross section of the rules (as illustrated in FIG. 6D), and particularly the relatively large gap between two adjacent rules when using such a rule cross section, allows the substrate 1130 to be pushed into gaps 1109 to a greater degree than when using rules having an angular cross section, thereby facilitating the clearer relief pattern on the substrate.

In the context of the present application and the claims herein, the term “substrate” relates to a workpiece having an impressionable substrate, which, following impression of a broad surface of the substrate by a die and counter-die system, under ambient and/or above-ambient conditions, the impression pattern, after disengagement from the die and counter-die system, is maintained or at least substantially maintained. Such substrates typically include fibrous paper substrates (including, but not limited to, paper, boxboard, cardboard, cardboard with a metalized coating, laminated paper, and laminated cardboard), and metal foils (e.g., aluminum foil, copper foil, and a shape memory metal alloy foil such as nitinol foils), as well as various plastic films, including shape memory plastic films such as polyurethane shape memory plastic films.

In some embodiments, the substrate 1130 may be a fibrous substrate such as paper, boxboard, or cardboard, and which may have a thickness in the range of 0.1 mm to 1 mm, in the range of 0.1 to 0.8 mm, or in the range of 0.2 mm to 0.5 mm n some embodiments, the substrate comprises 300 micron SBS,

In some embodiments the substrate may be a paper laminated with a plastic film such as a polypropylene or polyester film, and may have a total thickness in the range of 0.1 mm to 1 mm. In some embodiments, the substrate may be a paper covered in a metallic coating, and may have a total thickness in the range of 0.1 mm to 1 mm.

In some embodiments, the substrate may be a metal foil, such as aluminum foil or copper foil, which may have a thickness in the range of 0.02 mm to 0.2 mm.

In some embodiments, the substrate may be a shape memory metal alloy foil, such as a Nitinol foil, which may have a thickness in the range of 0.02 mm to 0.2 mm.

In some embodiments, the substrate may be a plastic substrate, such as polyvinylchloride, polypropylene, polycarbonate, or polyester, or a polyurethane shape memory plastic film, which may have a thickness in the range of 0.05 mm to 0.5 mm. In some such embodiments, impression of a relief pattern onto the substrate may be accomplished at an elevated temperature, as known in the art of hot embossing or thermal embossing. In some such embodiments, heat may be applied to the substrate internally by heating system base 1104, for example via running a hot liquid through the base or via electrical heating of the drum surface, or externally, for example by placing a heat source, such as a halogen lamp, adjacent the male die such that the substrate and/or the relief pattern is heated during the impression process,

Reference is now made to FIGS. 8A, 8B, and 8C, which are schematic cross-sectional diagram of embodiments of compressible counter films 1110, mounted on a film base 1112 and usable in the systems of FIGS. 7A and 7B, in accordance with aspects of the present invention.

FIG. 8A illustrates a basic compressible counter film 1110a mounted onto film base 1112, and including a base layer 1114, a compressible layer 1118, and a contact layer 1116, as described hereinabove with reference to FIGS. 7A and 7B,

In some embodiments, the base layer 1114, which may also be thought of as a supporting layer adapt to mechanically support the compressible counter film 1110, may have a thickness in the range of 0.15 mm to 1 mm.

In some embodiments, base layer 1114 includes a metalayer, such as an aluminum or steel layer.

In some embodiments, base layer 1114 includes a polymer layer, such as a PET layer.

In some embodiments, base layer 1114 includes a fabric, or textile layer, particularly a fabric layer, such as a polyester, rayon, or cotton layer. In some embodiments, the fabric layer may include a woven fabric, which in some embodiments has a density in the range of 10-30 threads/cm.

In some embodiments, base layer 1114 includes two or more layers of fabric, directly attached to one another, for example by lamination, adhesive, or any other suitable attachment method known in the art.

In some embodiments, the fabric forming base layer 1114 includes, or is impregnated with, a rubber based material, such as acrylonitrile butadiene copolymer rubber, chloroprene rubber, or EPDM rubber. The rubber based material may be introduced into the fabric using any suitable method known in the art, for example by coating the rubber material on the fabric with a blade coater or by calendering. In some embodiments, the rubber based material includes a vulcanizing agent such as organic peroxides, as well as sulfur, organic sulfur-containing compound, and the like. In some embodiments, the rubber based material includes a vulcanizing accelerator such as inorganic accelerators (e.g., calcium hydroxide, magnesia (MgO), and the like) and organic accelerators (e.g., thiurams, dithiocarbamates, and thiazoles). In some embodiments the rubber-based material includes a softening agent such as fatty acid, cottonseed oil, tall oil, an asphalt substance, paraffin wax, and the like.

The compressible layer 1118 is adapted to decrease lateral deformation resulting from pressure applied to compressible counter film 1110. Additionally, the compressible layer is adapted to enable the relief pattern impressed on the substrate to be sharper, for example by enabling increased debossing or creasing depths, sharper angles to debossed features or to crease lines, and the like.

In some embodiments, compressible layer 1118 has a thickness in the range of 0.15 mm to 5 mm, 0.15 mm to 4 mm, 0.15 mm to 3 mm, 0.15 mm to 2 mm, or 0.15 mm to 1 mm. In some embodiments, compressibility of the compressible layer 1118 is due to foam content therein.

In some embodiments, the compressible layer 1118 comprises a rubber foam layer, which may include a synthetic rubber as a rubber matrix thereof. In some such embodiments, the synthetic rubber may include one or more of acrylonitrile-butadiene copolymer rubber, butadiene rubber, polyisoprene rubber, butyl rubber, chloroprene rubber, EPDM rubber and polyurethane rubber. The compressible layer may be generated using any suitable method known in the art, such as, for example, the leaching method, as described in the Encyclopedia of Polymer Science and Technology, Concise, By Herman F. Mark, 3rd edition, or the foaming agent method, as described in The Complete Book on Rubber Processing and Compounding Technology (with Machinery Details), 2nd Revised Edition, MIR Board of Consultants and Engineers, 2016, both of which are incorporated by reference as if fully set forth herein. In some such embodiments, the supporting base used for the leaching method may be a fabric layer, such as a woven fabric layer. It will be appreciated that the foam content in the compressible layer 1118 may depend on the amount of water-soluble powder used in the leaching method.

The compressible layer 1118 may be directly attached to said base layer, for example by lamination or by means of an adhesive, or may be attached to intermediate layers, such as surface modulating layer 1140 or rubber layer 1144.

In some embodiments, the contact layer 1116 has a thickness in the range of 0.1 mm to 5 mm, 0.1 mm to 4 mm, 0.1 mm to 3 mm, 0.1 mm to 2 mm, or 0.1 mm to 1 mm, and a Shore A hardness in the range of 20-90, 30-90, 40-90, 50-90, 60-90, 20-70, 30-70, or 65-75. The contact layer 1116 comprises a rubber-based material, which, in some embodiments, includes at least one synthetic rubber. In some such embodiments, the synthetic tubber includes at least one of acrylonitrile-butadiene rubber (NBR), hydrogenated NBR, butadiene rubber, poly-isoprene rubber, butyl rubber chloroprene rubber (CR), EPDM rubber, polyurethane rubber, and acrylic rubber. In some embodiments, in addition to one or more synthetic rubbers, the contact layer 1116 further includes a polysulfide rubber.

In some embodiments, the rubber-based material further includes a vulcanizing agent, such as, for example, an organic peroxide (e.g., benzoyl peroxide and the like), sulfur, or an organic sulfur-containing compound (e.g., tetramethylthiuram disulfide, N,N-dithiobismorpholine, and the like). In some embodiments, the amount of added vulcanizing agent is in the range of 0.3 to 4 parts by weight, preferably 0.5 to 3 parts by weight, based on 100 parts by weight of the rubber material,

In some embodiments, the rubber-based material further includes a vulcanization accelerator, such as, for example, an inorganic accelerator (e.g., calcium hydroxide, magnesia (MgO), and the like) or an organic accelerator such as a thiuram (e.g., tetramethylthiuram disulfide, tetraethy—thiuram disulfide, and the like), a dithiocarbamate zinc dibutyldithiocarbamate, zinc diethyldithiocarbamate, and the like), a thiazole 2-mercaptobenzothiazole, N-dicyclohexyl-2-benzothiazole sulfenatnide, and the like.), and a thiourea (e.g., trimethylthiourea, 30 N,N′-diethylthiourea, and the like).

In some embodiments, the rubber-based material may further include an auxiliary vulcanization accelerator, a filler, a reinforcer, a softener, a plasticizer, and/or an antioxidant.

In some embodiments the rubber-based material may comprise a compressible rubber based material, such as rubber foam.

Turning to the embodiment illustrated in FIG. 8B, a compressible counter film 1110b is adapted to be mounted onto film base 1112. Compressible counter film 1110b includes base layer 1114, compressible layer 1118, and contact layer 1116, all substantially as described hereinabove, and further includes a surface modulating layer 1140. The surface modulating layer may have a thickness in the range of 0.15 mm to 1 mm.

The surface modulating layer 1140 may be attached along a first broad face thereof to the compressible layer 1118 and may be attached along a second broad face thereof to the contact layer 1116.

Without wishing to be bound by theory, it is understood by the Inventors that the surface modulation layer 1140 as described herein is adapted to inhibit or prevent contact layer 1116 from separating from compressible layer 1118, or from being rotationally shifted relative thereto, during impression of the relief pattern on the substrate.

Additionally, without wishing to be bound by theory, it is understood by the Inventors that when compressible layer 1118 is fully compressed, and additional pressure is applied to contact layer 1116, deformation formed in compressible layer 1118 are damped by surface modulation layer 1140, such that the deformation appearing on the contact surface of contact layer 1116 are modulated, for example lower or more spread out, than deformations appearing under the same pressure conditions in compressible counter film 1110a of FIG. 8A. As a result, when using compressible counter film 1110b, a greater amount of pressure that can be applied to contact layer 1116 at the time of impression without damaging the substrate 1130 or the relief pattern impressed thereon than when using compressible counter film 1110a.

In some embodiments, surface modulating layer 1140 includes a fabric layer impregnated with a rubber-based material. In some embodiments, the fabric layer may comprise a cotton, rayon, or polyester layer. In some embodiments, the fabric layer comprises a woven fabric that may have a density in the range of 10-30 threads/cm.

In some embodiments, surface modulating layer 1140 includes two or more layers of fabric, directly attached to one another, for example by lamination, adhesive, or any other suitable attachment method known in the art.

In some embodiments, the rubber-based material with which the fabric layer is impregnated includes at least one of acrylonitrile butadiene copolymer rubber, EPDM rubber, and chloroprene rubber. The rubber-based material may be introduced into the fabric using any suitable method known in the art, for example by coating the rubber material on the fabric with a blade coater or by calendering. In some embodiments, the rubber-based material includes a vulcanizing agent such as organic peroxides, as well as sulfur, organic sulfur-containing compound, and the like. In some embodiments, the rubber-based material includes a vulcanizing accelerator such as inorganic accelerators (e.g. calcium hydroxide, magnesia (MgO), and the like) and/or organic accelerators (e.g. thiurams, dithiocarbamates, thiazoles, and the like). In some embodiments, the rubber-based material includes a softening agent such as fatty acid, cottonseed oil, tall oil, an asphalt substance, paraffin wax, and the like.

Referring now to the embodiment illustrated in FIG. 8C, a compressible counter film 1110c is adapted to be mounted onto film base 1112. Compressible counter film 1110c includes base layer 1114, compressible layer 1118, and contact layer 1116, all substantially as described hereinabove, and further includes a reinforcing layer 1142 and a rubber layer 1144. The reinforcing layer 1142 may have a thickness in the range of 0.15 mm to 1 mm, and the rubber layer 1144 may have a thickness in the range of 0.15 mm to 5 mm, 0.15 mm to 4 mm, 0.15 mm to 3 mm, 0.15 mm to 2 mm, or 0.15 mm to 1 mm.

Reinforcing layer 1142 may be a fabric layer, such as a cotton, rayon, or polyester layer, which may include a woven fabric. In some embodiments, the woven fabric may be impregnated with rubber, substantially as described hereinabove with reference to base layer 1114 and to surface modulating layer 1140.

Rubber layer 1144 may include any suitable rubber, such as EPDM, polyurethane, natural rubber, silicone rubber, or bitumen rubber. The rubber layer may be formed by any suitable method known in the art, such as melting, emulation impregnation, dual component reactive materials, or cold and hot compressing.

In the illustrated embodiment reinforcing layer 1142 is disposed above, and immediately adjacent to, rubber layer 1144, and layers 1142 and 1144 are disposed between compressible layer 1118 and base layer 1114. However, it will be appreciated that reinforcing layer 1142 and rubber layer 1144 may be disposed in other locations between base layer 1114 and contact layer 1116.

In some embodiments, the compressible counter films 1110a, 1110b, and 1110c have a compressibility, in a direction perpendicular to a broad face thereof, in the range of 5-30%, 6-30%, 9-25%, 9-20%, or 9-15% at 1.35 MPa.

In some embodiments, the compressible counter films 1110a , 1110b, and 1110c may have a thickness in the range of 0.5 mm to 10 mm, 0.5 mm to 8 mm, or 1 mm to 7 mm. In some embodiments, the compressible counter films 1110a and 1110b may have a thickness in the range of 0.5 mm to 4 mm, 1 mm to 3 mm, or 1 mm to 2 mm. In some embodiments, the compressible counter film 1110c may have a thickness in the range of 2 mm to 8 mm or 3 mm to 7 mm.

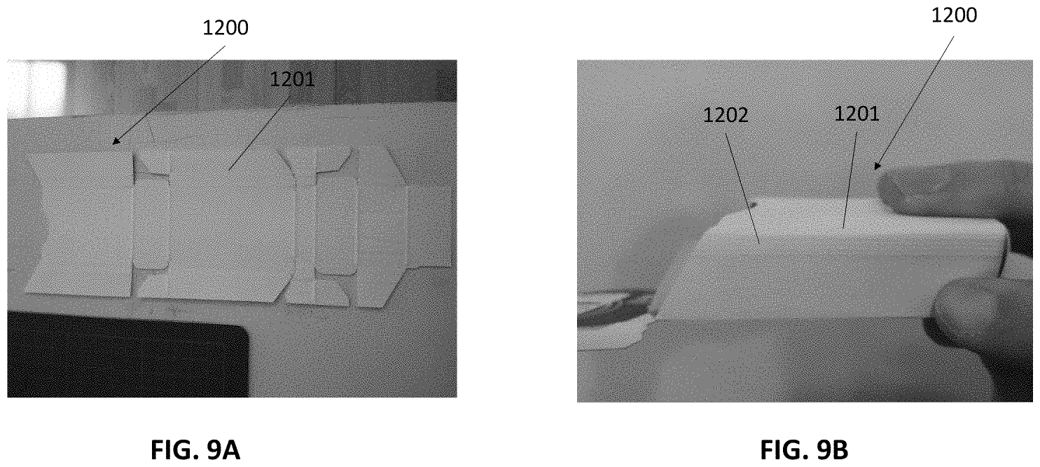

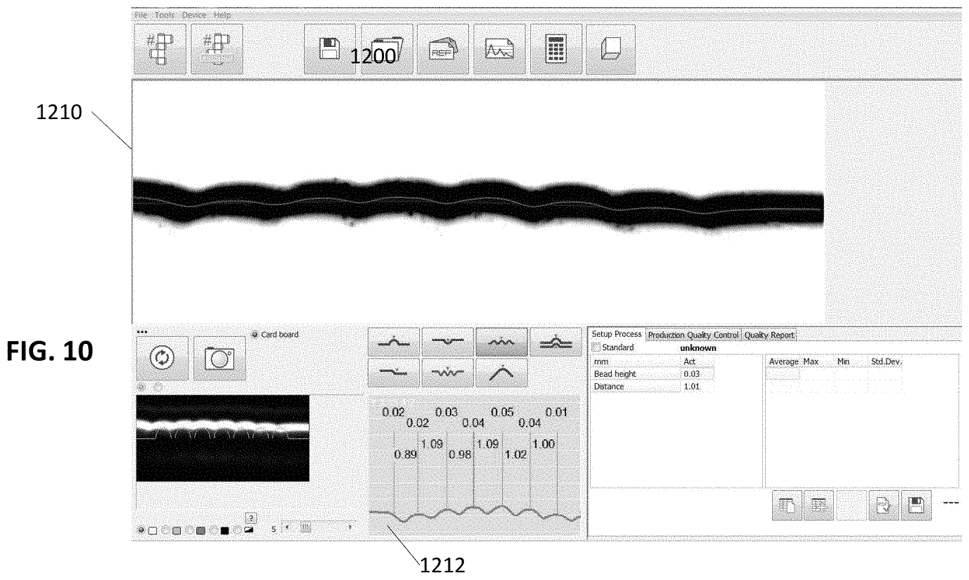

Reference is now made to FIGS. 9A and 9B, which are a schematic illustration of a substrate 1200 impressed with a relief pattern using the rule die of FIG. 6A and the system of FIG. 7B, in a spread out orientation and when folded along the relief pattern, respectively, and to FIG. 10, which provides a screenshot of a characterization of the relief pattern of the substrate of FIG. 9A.

As seen in FIG. 9A, following impression of the substrate 1200 with using the rule die of FIG. 6A and the system of FIG. 7B, the substrate 1200 has formed thereon a relief pattern 1201 includes multiple indentation lines 1202 formed in parallel.

Turning to FIG. 10, box 1210 thereof illustrates a cross section of the relief pattern 1201 of substrate 1200. Turning to box 1212, it is seen that the indentation lines 1202 each have a height in the range of 0.01 mm to 0.05 mm, which represents the degree to which the substrate 1200 was pushed into the gaps in the rule die, such as gaps 1109 of FIG. 7B, during impression of the relief pattern on the substrate. Additionally, it is seen that the distance between adjacent indentation lines 1202 is in the range of 0.98 mm to 1.08 mm, and thus is substantially identical, within a tolerance of 10 micrometers.

Turning to FIG. 9B, it is seen that when the substrate is folded along indentation lines 1202, the resulting fold is curved, and does not include a sharp angle as would result from folding a substrate along a single crease line.

In the context of the present application and of the claims herein, the term “attached” relates to direct attachment between two objects, attachment between two objects via an adhesive layer, or attachment between two objects via one or more intermediate objects or layers.

It will be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification, including PCT application publication number WO/2015/155685, PCT application publication number WO2011/145092, PCT application publication number WO2013/030828, U.S. Pat. Nos. 8,777,828, 9,102,818, 9,545,638, and U.S. patent application publication number 2017/0113432 are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A nozzle connectable to a rule drawing system for drawing a viscous material onto a substrate to form a plurality of parallel line rules of a rule die, comprising:
a nozzle body including a hollow bore adapted to receive the viscous material, said nozzle body having an exterior surface shaped and configured for connection to the rule drawing system; and
a nozzle tip terminating in a plurality of orifices optionally arranged along a straight line, each of said plurality of orifices being in fluid communication with said bore, said plurality of orifices adapted to allow passage of the viscous material therethrough, thereby to form the plurality of parallel line rules.

2. The nozzle of claim 1, wherein the distance between each two adjacent ones of said plurality of orifices is in the range of 0.5 mm to 6.0 mm, 0.5 mm to 5.5 mm, 0.5 mm to 5.0 mm, 0.5 mm to 4.5 mm, 0.5 mm to 4.0 mm, 0.5 mm to 3.5 mm, 0.5 mm to 3.0 mm, 0.5 mm to 2.5 mm, or 0.5 mm to 2.0 mm.

3. The nozzle of claim 1 or claim 2, wherein distal orifices of said plurality of orifices, located at ends of said line, have a greater cross section than others of said plurality of orifices.

4. The nozzle of any one of claims 1 to 3, wherein each two adjacent ones of said plurality of orifices are separated by a common wall.

5. The nozzle of claim 4, each said common wall having a width in the range of 0.5 mm to 6.0 mm, 0.5 mm to 5.5 mm, 0.5 mm to 5.0 mm, 0.5 mm to 4.5 mm, 0.5 mm to 4.0 mm, 0.5 mm to 3.5 mm, 0.5 mm to 3.0 mm, 0.5 mm to 2.5 mm, or 0.5 mm to 2.0 mm.

6. The nozzle of any one of claims 1 to 5, wherein each of said plurality of orifices includes a bottom opening substantially parallel to a bottom surface of said nozzle body.

7. The nozzle of any one of claims 1 to 6, wherein each of the plurality of orifices includes a single side opening disposed perpendicularly to a bottom surface of said nozzle body, and in parallel to said straight line.

8. The nozzle of claim 7, wherein, in each of said plurality of orifices, said single side opening and said bottom opening form an L shape.

9. The nozzle of any one of claims 1 to 8, wherein each of said plurality of orifices has a width in the range of 0.5 mm to 1.0 mm, 0.6 mm to 0.9 mm, 0.65 mm to 0.85 mm, 0.7 mm to 0.85 mm, or 0.75 mm to 0.85 mm.

10. The nozzle of any one of claims 1 to 9, wherein each of said plurality of orifices has a height in the range of 1.1 mm to 1.5 mm, 1.15 mm to 1.45 mm, 1.2 mm to 1.4 mm, or 1.25 mm to 1.35 mm.

11. The nozzle of any one of claims 1 to 8, wherein, for each of said plurality of orifices, a ratio of a height of the orifice to a width of the orifice is in the range of 1 to 3, 1.1 to 2.7, 1.2 to 2.5, 1.4 to 2,4, 1.5 to 2.3, 1.7 to 2.1, 1.8 to 2, or 1,8 to 1.9.

12. The nozzle of any one of claims 1 to 11, wherein openings of said plurality of orifices all have the same cross sectional shape.

13. The nozzle of any one of claims 1 to 11, wherein openings of some of said plurality of orifices have a first cross sectional shape, and openings of others of said plurality of orifices have a second cross sectional shape, the first and second cross sectional shapes being different from one another.

14. The nozzle of any one of claims 1 to 13, wherein openings of at least some of said plurality of orifices have a rectangular cross section.

15. The nozzle of any one of claims 1 to 13, wherein openings of at least some of said plurality of orifices have a trapezoidal cross section.

16. The nozzle of any one of claims 1 to 13, wherein openings of at least some of said plurality of orifices have an arcuate cross section.

17. The nozzle of any one of claims 1 to 13, wherein openings of at least some of said plurality of orifices have a triangular cross section.

18. The nozzle of any one of claims 1 to 17, wherein a number of orifices in said plurality of orifices is in the range of 2 to 30, 2 to 28, 2 to 25, 2 to 22, 2 to 20, 2 to 18, or 2 to 15.

19. A method for producing a male die suitable for impressing a relief pattern, the method comprising:
mounting a die base onto a rule drawing system including the nozzle of any one of claims 1 to 18; and
using said rule drawing system, pressuring the viscous material via said bore and out of said plurality of orifices onto said die base, thereby to form a plurality of line rules disposed in parallel on said die base.

20. The method of claim 19, wherein said plurality of line rules each have a height in the range of 0.3 mm to 5.0 mm, 0.3 mm to 4.5 mm, 0.3 mm to 4.0 mm, 0.3 mm to 3.5 mm, 0.3 mm to 3.0 mm, 0.4 mm to 2.5 mm, or 0.5 mm to 2.0 mm.

21. The method of claim 19 or claim 20, wherein said plurality of line rules have substantially the same height, such that a height difference between any two of said plurality of line rules is not more than 50 micrometers, not more than 40 micrometers, not more than 30 micrometers, or not more than 20 micrometers.

22. The method of any one of claims 19 to 21, wherein said plurality of line rules have substantially the same width, such that a width difference between any two of said plurality of line rules is not more than 50 micrometers, not more than 40 micrometers, not more than 30 micrometers, or not more than 20 micrometers.

23. The method of any one of claims 19 to 22, wherein said plurality of line rules each have a width, at a base thereof, in the range of 0.3 mm to 5.0 mm, 0.3 mm to 4.5 mm, 0.3 mm to 4.0 mm, 0.3 mm to 3.5 mm, 0.3 mm to 3.0 mm, 0.4 mm to 2.5 mm, or 0.5 mm to 2.0 mm.

24. The method of any one of claims 19 to 23, wherein said plurality of line rules each have a width, at a tip thereof, in the range of 0.1 mm to 5.0 mm, 0.1 mm to 4.5 mm, 0.1 mm to 4.0 mm, 0.1 mm to 3.5 mm, 0.1 mm to 3.0 mm, 0.1 mm to 2.5 mm, 0.2 mm to 2.0 mm, 0.3 mm to 1.5 mm, or 0.3 mm to 1.0 mm.

25. The method of any one of claims 19 to 24, wherein a distance between two adjacent ones of said plurality of line rules, at a base thereof, is in the range of 0 mm to 5.0 mm, 0.1 mm to 4.5 mm, 0.2 mm to 4.0 mm, 0.3 mm to 3.5 mm, 0.3 mm to 3.0 mm, 0.4 mm to 2.5 mm, or 0.5 mm to 2.0 mm.

26. The method of any one of claims 19 to 25, wherein a distance between two adjacent ones of said plurality of line rules, at a tip thereof, is in the range of 0.2 mm to 4.0 mm, 0.3 mm to 3.5 mm, 0.4 mm to 3.5 mm, 0.5 mm to 3.0 mm, 0.6 mm to 2.5 mm, or 0.7 mm to 2.0 mm.

27. The method of any one of claims 19 to 26, wherein at least one of said plurality of line rules has a trapezoidal cross section.

28. The method of any one of claims 19 to 27, wherein at least one of said plurality of line rules has an arcuate cross section.

29. The method of any one of claims 19 to 28, wherein at least one of said plurality of line rules has a rectangular cross section.

30. The method of any one of claims 19 to 29, wherein at least one of said plurality of line rules has a rectangular cross section.

31. The method of any one of claims 19 to 30, wherein said plurality of line rules have substantially the same cross section.

32. The method of any one of claims 19 to 30, wherein at least one of said plurality of line rules has a first cross section, and at least one other of said plurality of line rules has a second cross section, said first cross section having a different shape from said second cross section.

33. The method of any one of claims 19 to 32, wherein said plurality of line rules includes a number of line rules in the range of 2 to 30, 2 to 28, 2 to 25, 2 to 22, 2 to 20, 2 to 18, or 2 to 15.

34. The method of any one of claims 19 to 33, wherein said viscous material comprises a polymeric resin.

35. A system for producing a male die suitable for impressing a relief pattern using the nozzle of any one of claims 1 to 18, as described with respect to FIGS. 2-5.

36. A system for impressing a relief pattern onto a substrate, the relief pattern including a plurality of line indentations disposed in parallel, the system comprising:
at least one male die including a plurality of line rules disposed in parallel defined on a contact surface thereof;
a compressible counter film including:
a base layer;
a contact layer disposed opposite said contact surface of said at least one male die and spaced therefrom; and
a compressible layer disposed between said base layer and said contact layer and attached thereto,
said contact layer being featureless in a region thereof opposing the relief pattern on said at least one male die; and
a compression mechanism adapted to move said at least one male die and said compressible counter film towards one another in an operative mode;
wherein, in said operative mode, when the substrate is disposed between said contract surface and said contact layer, said compression mechanism moves said at least one male die and said compressible counter film towards one another, such that said at least one male die engages a first broad surface of the substrate and said contact layer of said compressible counter film engages an opposing broad surface of the substrate, so as to impress the relief pattern on the substrate.

37. The system of claim 36, wherein said plurality of line rules each have a height in the range of 0.3 mm to 5.0 mm, 0.3 mm to 4.5 mm, 0.3 mm to 4.0 mm, 0.3 mm to 3.5 mm, 0.3 mm to 3.0 mm, 0.4 mm to 2.5 mm, or 0.5 mm to 2.0 mm.

38. The system of claim 36 or claim 37, wherein said plurality of line rules have substantially the same height, such that a height difference between any two of said plurality of line rules is not more than 50 micrometers, not more than 40 micrometers, not more than 30 micrometers, or not more than 20 micrometers.

39. The system of any one of claims 36 to 38, wherein said plurality of line rules have substantially the same width, such that a width difference between any two of said plurality of line rules is not more than 50 micrometers, not more than 40 micrometers, not more than 30 micrometers, or not more than 20 micrometers.

40. The system of any one of claims 36 to 39, wherein said plurality of line rules each have a width, at a base thereof, in the range of 0.3 mm to 5.0 mm, 0.3 mm to 4.5 mm, 0.3 mm to 4.0 mm, 0.3 mm to 3.5 mm, 0.3 mm to 3.0 mm, 0.4 mm to 2.5 mm, or 0.5 mm to 2.0 mm.

41. The system of any one of claims 36 to 40, wherein said plurality of line rules each have a width, at a tip thereof, in the range of 0.1 mm to 5.0 mm, 0.1 mm to 4.5 mm, 0.1 mm to 4.0 mm, 0.1 mm to 3.5 mm, 0.1 mm to 3.0 mm, 0.1 mm to 2.5 mm, 0.2 mm to 2.0 mm, 0.3 mm to 1.5 mm, or 0.3 mm to 1.0 mm.

42. The system of any one of claims 36 to 41, wherein a distance between two adjacent ones of said plurality of line rules, at a base thereof, is in the range of 0 mm to 5.0 mm, 0.1 mm to 4.5 mm, 0.2 mm to 4.0 mm, 0.3 mm to 3.5 mm, 0.3 mm to 3.0 mm, 0.4 mm to 2.5 mm, or 0.5 mm to 2.0 mm.

43. The system of any one of claims 36 to 42, wherein a distance between two adjacent ones of said plurality of line rules, at a tip thereof, is in the range of 0.2 mm to 4.0 mm, 0.3 mm to 3.5 mm, 0.4 mm to 3.5 mm, 0.5 mm to 3.0 mm, 0.6 mm to 2.5 mm, or 0.7 mm to 2.0 mm.

44. The system of any one of claims 36 to 43, wherein at least one of said plurality of line rules has a trapezoidal cross section.

45. The system of any one of claims 36 to 44, wherein at least one of said plurality of line rules has an arcuate cross section.

46. The system of any one of claims 36 to 45, wherein at least one of said plurality of line rules has a rectangular cross section.

47. The system of any one of claims 36 to 46, wherein at least one of said plurality of line rules has a triangular cross section.

48. The system of any one of claims 36 to 47, wherein said plurality of line rules have substantially the same cross section.

49. The system of any one of claims 36 to 47, wherein at least one of said plurality of line rules has a first cross section, and at least one other of said plurality of line rules has a second cross section, said first cross section having a different shape from said second cross section.

50. The system of any one of claims 36 to 49, wherein said plurality of line rules includes a number of line rules in the range of 2 to 30, 2 to 28, 2 to 25, 2 to 22, 2 to 20, 2 to 18, or 2 to 15.

51. The system of any one of claims 36 to 50, wherein said system is adapted to be used, in said operative mode, to impress the relief pattern on at least 5000, at least 10000, at least 20000, at least 30000, or at least 40000 individual substrates, without reduction of quality of the impressed relief pattern,

52. The system of any one of claims 36 to 51, wherein said system is adapted to be used, in said operative mode, to impress the relief pattern on at least 1000, at least 1500, or at least 2000, individual substrates per hour.

53. The system of any one of claims 36 to 52, said compressible counter film further including:
a reinforcing fabric layer adapted to provide structural reinforcement to said compressible counter film; and
a rubber layer attached along a broad face thereof to said reinforcing fabric layer.

54. The system of any one of claims 36 to 52, said compressible counter film further including a surface modulating layer disposed between said base layer and said contact layer and adapted such that, in said operative mode, when pressure applied to said contact layer exceeds an amount of pressure required to fully compress said compressible layer, said surface modulating layer responds by modulating at least one of a height and a surface area of a deformation formed on said contact layer.

55. The system of any one of claims 36 to 54, wherein said compressible layer is adapted to decrease lateral deformation resulting from pressure applied to said compressible counter film.

56. The system of any one of claims 36 to 55, wherein at least one of said at least one male die and said compressible counter film is mounted onto a rotating drum.

57. The system of any one of claims 36 to 56, wherein said at least one male die is mounted onto a first rotating drum and said compressible counter film is mounted onto a second rotating drum.

58. The system of any one of claims 36 to 57, wherein, upon application of pressure to said compressible counter film, said compressible layer absorbs the pressure by compressing until said compressible layer is substantially incompressible.

59. The system of any one of claims 36 to 58, wherein the substrate comprises a fibrous substrate.

60. The system of claim 59, wherein said fibrous substrate comprises paper.

61. The system of claim 60, wherein said paper comprises a paper coated by a metal foil.

62. The system of claim 60, wherein said paper comprises a paper coated by a plastic coating.

63. The system of any one of claims 59 to 62, wherein said substrate has a thickness in the range of 0.1-1 mm, 0.1 to 0.8 mm, or 0.2 to 0.5 mm.

64. The system of any one of claims 59 to 63, wherein said substrate has a thickness of 0.3 mm.

65. The system of any one of claims 36 to 58, wherein the substrate comprises a metal foil.

66. The system of claim 65, wherein said metal foil is selected from the group consisting of a copper foil and an aluminum foil.

67. The system of claim 65, wherein said metal foil comprises a shape memory metal alloy foil.

68. The system of any one of claims 65 to 67, wherein said metal foil has a thickness in the range of 0.02 mm to 0.2 mm.

69. The system of any one of claims 36 to 58, wherein the substrate comprises a plastic substrate.

70. The system of claim 69, wherein said plastic substrate has a thickness in the range of 0.05 mm to 0.5 mm.

71. The system of claim 69 or claim 70, further comprising a heating mechanism for applying heat to said plastic substrate during impression of the relief pattern thereon,

72. A method for impressing relief pattern on a substrate, the relief pattern including a plurality of line indentations disposed in parallel, the method comprising:
placing a substrate between at least one male die and a compressible counter film,
wherein the at least one male die includes a contact surface defining the relief pattern, said contact surface including a plurality of line rules disposed in parallel,
and wherein the compressible counter film includes:
a base layer;
a contact layer disposed opposite said contact surface of said at least one male die and spaced therefrom; and
a compressible layer disposed between said base layer and said contact layer and attached thereto,
said contact layer being featureless in a region thereof opposing the relief pattern on said at least one male die; and
moving said at least one male die and said compressible counter film towards one another such that said at least one male die engages a first broad surface of the substrate and said contact layer of said compressible counter film engages an opposing broad surface of the substrate so as to impress the relief pattern on the substrate.

73. The method of claim 72, wherein the relief pattern impressed on the substrate includes a plurality of line indentations disposed in parallel.

74. The method of claim 73, wherein each of the plurality of line indentations has a height in the range of 0.01 mm to 0.5 mm, 0.01 mm to 0.3 mm, 0.01 mm to 0.2 mm, 0.01 mm to 0.1 mm, 0.01 mm to 0.08 mm, or 0.01 to 0.05 mm.

75. The method of any one of claims 72 to 74, wherein said moving comprises pressing portions of said substrate into gaps defined between said plurality of line rules.

76. The method of claim 75, wherein said pressing portions of said substrate comprises pressing said portions of said substrate into said gaps to a depth of at least 10 micron, at least 20 microns, at least 50 microns, at least 100 microns, or at least 250 microns.

77. The method of claim 75 or claim 76, wherein said pressing portions of said substrate comprises pressing said portions of said substrate into said gaps to a depth of not more than 1.5 mm, not more than 1.2 mm, not more than 1 mm, not more than 800 microns, or not more than 500 microns.

78. The method of any one of claims 72 to 77, wherein the substrate comprises a fibrous substrate.

79. The method of claim 78, wherein said fibrous substrate comprises a paper.

80. The method of claim 79, wherein said paper comprises a paper coated by a metal foil.

81. The method of claim 79, wherein said paper comprises a paper coated by a plastic coating.

82. The method of any one of claims 78 to 81, wherein said substrate has a thickness in the range of 0.1-1 mm, 0.1 mm to 0.8 mm, or 0.2 mm to 0.5 mm.

83. The method of any one of claims 78 to 82, wherein said substrate has a thickness of 0.3 mm.

84. The method of any one of claims 72 to 77, wherein the substrate comprises a metal foil.

85. The method of claim 84, wherein said metal foil has a thickness in the range of 0.02 mm to 0.2 mm.

86. The method of any one of claims 72 to 77, wherein the substrate comprises a plastic substrate.

87. The method of claim 86, wherein said plastic substrate has a thickness in the range of 0.05 mm to 0.5 mm.

88. The method of claim 86 or claim 87, further comprising applying heat to said plastic substrate during impression of the relief pattern thereon.

89. A method for producing a rounded fold in a substrate, the method comprising:
placing a substrate between at least one male die and a compressible counter film,
wherein the at least one male die includes a contact surface including a plurality of line rules disposed in parallel,
and wherein the compressible counter film includes:
a base layer;
a contact layer disposed opposite said contact surface of said at least one male die and spaced therefrom; and
a compressible layer disposed between said base layer and said contact layer and attached thereto,
said contact layer being featureless in a region thereof opposing the relief pattern on said at least one male die;
moving said at least one male die and said compressible counter film towards one another such that said at least one male die engages a first broad surface of the substrate and said contact layer of said compressible counter film engages an opposing broad surface of the substrate so as to impress a plurality of line indentations, disposed in parallel, on the substrate; and
folding said substrate along said plurality of line indentations, thereby to form the rounded fold.

90. The method of claim 89, wherein each of the plurality of line indentations has a height in the range of 0.01 mm to 0.5 mm, 0.01 mm to 0.3 mm, 0.01 mm to 0.2 mm, 0.01 mm to 0.1 mm, 0.01 mm to 0.08 mm, or 0.01 to 0.05 mm.

91. The method of any one of claims 89 to 90, wherein said moving comprises pressing portions of said substrate into gaps defined between said plurality of line rules.

92. The method of claim 91, wherein said pressing portions of said substrate comprises pressing said portions of said substrate into said gaps to a depth of at least 10 micron, at least 20 microns, at least 50 microns, at least 100 microns, or at least 250 microns.

93. The method of claim 91 or claim 92, wherein said pressing portions of said substrate comprises pressing said portions of said substrate into said gaps to a depth of not more than 1.5 mm, not more than 1.2 mm, not more than 1 mm, not more than 800 microns, or not more than 500 microns.

94. The method of any one of claims 89 to 93, wherein the substrate comprises a fibrous substrate.

95. The method of claim 94, wherein said fibrous substrate comprises a paper.

96. The method of claim 95, wherein said paper comprises a paper coated by a metal foil.

97. The method of claim 95, wherein said paper comprises a paper coated by a plastic coating.

98. The method of any one of claims 94 to 97, wherein said substrate has a thickness in the range of 0.1-1 mm, 0.1 mm to 0.8 mm, or 0.2 mm to 0.5 mm.

99. The method of any one of claims 94 to 98, wherein said substrate has a thickness of 0.3 mm.

100. The method of any one of claims 89 to 93, wherein the substrate comprises a metal foil.

101. The method of claim 100 wherein said metal foil has a thickness in the range of 0.02 mm to 0.2 mm.

102. The method of any one of claims 89 to 93, wherein the substrate comprises a plastic substrate.

103. The method of claim 102, wherein said plastic substrate has a thickness in the range of 0.05 mm to 0.5 mm.

104. The method of claim 102 or claim 203, further comprising applying heat to said plastic substrate during impression of the relief pattern thereon.
